(19) United States
(12) Patent Application Publication
(10) Pub. No.: US 2026/0109798 A1
(43) Pub. Date: Apr. 23, 2026

(54) PROCESS FOR THE PRODUCTION OF GRAFTED POLYPROPYLENE

(71) Applicants: TOTALENERGIES ONETECH, Courbevoie (FR); UNIVERSITÉ CLAUDE BERNARD LYON 1 (UCBL), Villeurbanne (FR); CENTRE NATIONAL DE LA RECHERCHE SCIENTIFIQUE (CNRS), Paris (FR); UNIVERSITÉ JEAN MONNET SAINT-ETIENNE, Saint-Etienne Cedex 2 (FR); INSTITUT NATIONAL DES SCIENCES APPLIQUÉES DE LYON (INSA LYON), Villeurbanne CEDEX (FR)

(72) Inventors: Olivier LHOST, Seneffe (BE); Pascal NAVEZ, Seneffe (BE); Yves TROLEZ, Seneffe (BE); Philippe CASSAGNAU, Villeurbanne (FR); Mohammad ABOU-TAHA, Saint Genis Pouilly (FR); Karim DELAGE, Villeurbanne (FR); Emmanuel BEYOU, Villeurbanne (FR)

(21) Appl. No.: 19/153,848

(22) PCT Filed: Feb. 13, 2024
(86) PCT No.: PCT/EP2024/053605

§ 371 Date: Aug. 5, 2025

(30) Foreign Application Priority Data
Feb. 14, 2023 (EP) 23315030.9

(51) Int. Cl. C08F 255/02

(52) U.S. Cl. CPC C08F 255/02

(57) ABSTRACT

The disclosure relate to a process for grafting a polypropylene-containing material to produce a modified polypropylene composition comprising the steps of providing an extruder with thermal regulation devices; providing a polypropylene-containing material comprising at least 50 wt. % of polypropylene based on the total weight of the polypropylene-containing material; providing a grafting agent in a content ranging from 0.8 to 10.0 wt. % based on the total weight of the polypropylene-containing material provided in step (b), wherein the grafting agent comprises at least one double bound per molecule; extruding the polypropylene-containing material and the grafting agent to obtain a modified polypropylene composition; wherein said step comprises a thermal treatment of the polypropylene-containing material at a maximum barrel temperature Ts of at least 345° C. to at most 440° C. in one or more hot zones of the extruder; and recovering a modified polypropylene composition.

### TECHNICAL FIELD

The present disclosure relates to processes to produce modified polypropylene compositions, with preference comprising recycled polypropylene, as well as such modified polypropylene compositions. In particular, the present disclosure relates to modified polypropylene compositions that can be used as a compatibilizing agent and are suitable for composite material production.

### TECHNICAL BACKGROUND

Polyolefins represent 40% of the global production of plastic materials. There is hence a clear necessity to develop new sustainable means of recycling these materials. Nowadays, the mechanical recycling of polyolefins is one of the most viable solutions for sustainable development because it relies on well-known technologies already in use like the compatibilization of mixtures of polymers and their formulations. The thermal degradation of plastic waste has been already developed via pyrolysis to transform the material into liquid fuel or waxes.

PP-g-MA i.e., polypropylene modified with maleic anhydride (MA) as a polar co-monomer, is a commercially available product that exhibits enhanced adhesion between polar and apolar products. It is thus used as a compatibilizing agent, improving mechanical properties, for example in wood-plastic composites, glass fiber-polypropylene composites, elastomers blends, polyamide-polyolefins compatibilizations. The presence of grafted MA on polypropylene (PP) enhances the processability as well as the miscibility of some polymer mixtures thanks to its polar nature. Moreover, the PP-g-MA can be used as a chemical precursor thanks to its carboxylic functions, allowing the synthesis of new copolymers; or even being used as raw material for the elaboration of new foams.

FR 1 516 084 A discloses a process for preparing a composition emulsifiable from a polyolefin wherein, a crystalline polymer having an inherent viscosity greater than 0.5, is heated with an organic polycarboxylic acid no saturated or a derivative of such an acid, in the absence of oxygen, at a temperature between 30° and 400° C., for a period including between 15 minutes and 2 hours, to obtain a product uncrosslinked and emulsifiable, having a saponification index at less than 6, a melt viscosity at 190° C. between 0.1 Pi and 5.0 Pi and a lower viscosity less than 0.5.

U.S. Pat. No. 5,474,694 A relates to an additive composition comprising a graft and amine derivatized copolymer prepared from ethylene and at least one (C3-C10) alpha-mono olefin and, optionally, a polyene selected from non-conjugated dienes and trienes comprising from about 15 to 80 mole percent of ethylene, from about 20 to 85 mole percent of said (C3-C10) alpha-mono olefin and from about 0 to 15 mole percent of said polyene, said copolymer having a number average molecular weight ranging from about 5,500 to 50,000 and having grafted thereon at least 1.8 molecules of a carboxylic acid acylating function per molecule of said copolymer and reacting said grafted copolymer with an amino alcohol compound selected from the group consisting of a 2-Anilinoalcohol, a (2-hydroxyalkyl) pyrridine, a 4-(2-hydroxyalkyl) morpholine, a 1-(2-hydroxyalkyl) piperazine, a 1-(2-pyrrolidine and a 1-(2-hydroxyalkyl) 2-pyrrolidine.

WO2016/025317 A1 is about a linear low-density polyethylene grafted with maleic anhydride (MAH-g-LLDPE).

WO2008/101647 is about a method for grafting maleic anhydride to polymers, comprising the steps of: melting an ethylene polymer by heating and down-shearing the polymer in a co-rotating, twin-screw extruder while injecting maleic anhydride and a free radical initiator into a polymer filled, pressurized section of the extruder; and mixing the polymer and the maleic anhydride in the extruder for sufficient time to graft the maleic anhydride wherein the free radical initiator is an organic peroxide that has a half-life (t½) of more than 1 second if measured in mono-chlorobenzene at 240° C.

There is a global request from the market to have cleaner resins, i.e. resins with the lowest possible content in residuals. Of course, when peroxides are introduced to produce grafted polypropylene, the final products contain the decomposition products of the peroxides. There are more and more requests from the market to get rid of these peroxide degradation products and to have cleaner grades.

The disclosure further aims to broaden the range of polypropylene-containing materials that can be used as starting materials for the production of modified polypropylene composition suitable to be used as compatibilizing agents in the production of composite material and/or as raw material in the production of copolymers or foams; wherein high grafting percentage is obtained.

### SUMMARY

It has now been found that one or more of the above-mentioned needs can be fulfilled by performing a single extrusion of existing polypropylene-containing material, such as recycled polypropylene-containing material resulting in a new modified polypropylene composition that has an improved balance of properties

According to a first aspect, the present disclosure relates to a process for grafting a polypropylene-containing material to produce a modified polypropylene composition remarkable in that it comprises the following steps:
a) providing a twin screw extruder with thermal regulation devices;
b) providing a polypropylene-containing material comprising at least 50 wt. % of polypropylene based on the total weight of the polypropylene-containing material;
c) providing a grafting agent in a content ranging from 0.8 to 10.0 wt. % based on the total weight of the polypropylene-containing material provided in step (b), wherein the grafting agent comprises at least one double bound per molecule;
d) extruding the polypropylene-containing material and the grafting agent to obtain a modified polypropylene composition; wherein said step comprises a thermal treatment of the polypropylene-containing material at a maximum barrel temperature Ts of at least 345° C. to at most 440° C. in one or more hot zones of the extruder with a residence time of less than 10 minutes; and
e) recovering a modified polypropylene composition:
   wherein the maximum barrel temperature Ts is obtained by self-heating of the material wherein the one or more hot zones have a total length equal to or greater than 6 D with D being the screw diameter, wherein the screw profile comprises at least one hot zone with successive kneading blocks elements over a length of at least 4 D followed by a left-handed element with D being the screw diameter, wherein the thermal regulation devices, are set to initial imposed barrel temperatures ranging between 24° and 320° C. and are switched off when the barrel temperature in the zone spontaneously exceeds the imposed barrel temperature by at least 3° C. without the need of external heat application.

Surprisingly, it was found that it is possible to produce a cleaner modified polypropylene composition and at the same time upgrade an initial polypropylene-containing material to a higher melt index and lower viscosity at a very high temperature. This finding allows using viscous polypropylene (such as viscous recycled polypropylene fluxes) for the production of modified polypropylene compositions with high melt index, i.e., suitable for use as a compatibilizing agent. The process is remarkable in its simplicity since it can be performed in a twin-screw extruder. The process is also remarkable by its simplicity since the grafting is performed by extrusion at high barrel temperature Ts and does not require the use of other agents for initiation, in particular, peroxide initiation is not required, nor any sophisticated apparatus for Free Radical initiation (such as ultrasound, UV, etc.)

The process is also remarkable because there is no chemical way to perform the scission of the polypropylene chain and the grafting. The increase of the melt index by a factor of at least 10 or at least 20 together with a high grafting level obtained by the specific extrusion conditions allows replying to long-felt need in the recycling field by enlarging the possible applications for the recycled feedstock.

Thus, it is preferred that the process is performed without peroxides and/or ultrasounds.

According to a second aspect, the present disclosure relates to a modified polypropylene composition remarkable in that it is produced by the process according to the first aspect.

According to a third aspect, the present disclosure relates to a modified polypropylene composition comprising at least 50 wt. % of polypropylene based on the total weight of the modified polypropylene composition, remarkable in that the modified polypropylene composition has:
a melt index MI₂ ranging from 10.0 to 600.0 g/10 min as determined according to ISO 1133-2011 at 230° C. under a load of 2.16 kg;
an Mz below 1,000,000 g/mol as determined by size exclusion chromatography;
a ratio of complex viscosity at a frequency of 0.01 rad/sec to the complex viscosity at a frequency of 100 rad/sec of at most 8.0, said ratio being measured at 190° C.;
a tan delta at 0.1 rad at 190° C. above 2.5; and
a grafting agent content of at least 0.3 wt. % based on total weight of the modified polypropylene composition;
   with preference, the modified polypropylene composition has an Mz below 600,000 g/mol as determined by size exclusion chromatography.

According to a fourth aspect, the present disclosure relates to a method to produce a composite material remarkable in that it comprises in a first step producing a modified polypropylene composition from a polypropylene-containing material according to the process according to the first aspect and in a second step melt-blending the modified polypropylene composition with one or more fillers to produce a composite material; with preference, the polypropylene-containing material is a recycled polypropylene-containing material.

For example, the one or more fillers are selected from talc mineral filler, wollastonite, calcium carbonate, modified calcium carbonate, coated calcium carbonate, glass fibres, wood fibres, bamboo fibres, flax fibres, hemp fibres, carbon fibres, metal fibres, graphite fibres, silica fibres, silica-alumina fibres, alumina fibres, zirconia fibres, boron nitride fibres, silicon nitride fibres, boron fibres, potassium titanate whisker, aluminium borate whisker, magnesium-based whisker, silicon-based whisker, carbon black, carbon nanotubes, graphene nanotubes, and any mixture thereof; with preference, the composite material is a wood-plastic composite comprising the modified polypropylene composition and wood fibres.

One or more of the following can be used to further define the process according to the invention; and the modified polypropylene composition.

In an embodiment, the thermal treatment is performed by self-heating of the material in a twin screw extruder, and the screw profile comprises two or more hot zones wherein a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter.

In an embodiment, the thermal treatment is performed by self-heating of the material in a twin-screw extruder and the successive kneading blocks elements of at least one hot zone of the extruder comprise disks with disks offset by 90 degrees and a disk width of at least 0.3 D wherein D being the screw diameter and/or in that one hot zone of the extruder is or comprises the melting zone of the extruder.

For example, step (d) of extruding the polypropylene-containing material comprises performing the extrusion at a screw speed ranging from 100 to 1200 rpm; preferably ranging from 300 to 900 rpm or from 400 to 800 rpm.

For example, step (d) of extruding the polypropylene-containing material comprises performing the extrusion with a residence time of less than 10 minutes such as ranging from 10 seconds to less than 10 minutes; preferably with a residence time ranging from 15 seconds to 8 minutes; or with a residence time ranging from 20 seconds to 5 minutes; more preferably with a residence time ranging from 10 to 180 seconds; even more preferably, from 10 to 120 seconds; most preferably, from 20 to 100 seconds; and even most preferably, from 30 to 80 seconds.

In a preferred embodiment, the process is devoid of a step of providing one or more peroxides. In such an embodiment no peroxides are used so the content of peroxide is 0 ppm.

In an embodiment, the process comprises providing one or more peroxides wherein the content of peroxide is at most 500 ppm based on the total weight of the polypropylene-containing material.

In an embodiment, the polypropylene-containing material is selected to have a melt index (MI₂ R) ranging from 0.1 to 20.0 g/10 min as determined according to ISO 1133-2011 at 230° C. under a load of 2.16 kg; preferably ranging from 0.1 to 15.0 g/10 min or from 0.2 to 10.0 g/10 min; more preferably from 0.3 to 8.0 g/10 min, or from 0.4 to 6.0 g/10 min, or ranging from 0.5 to 5.0 g/10 min; even more preferably ranging from 0.6 to 4.5 g/10 min of from 0.7 to 4.0 g/10 min, or from 0.8 to 3.0 g/10 min.

For example, the initial polypropylene-containing material is selected to have an Mz above 800,000 g/mol as determined by size exclusion chromatography; preferably above 1,000,000 g/mol; more preferably above 1,200.00 g/mol.

For example, the initial polypropylene-containing material is selected to have an Mw/Mn ranging from 2.2 to 30.0 as determined by size exclusion chromatography; preferably from 3.5 to 20.0; more preferably, from 5.0 to 15.0.

For example, the initial polypropylene-containing material is selected to have a complex viscosity at a frequency of 0.01 rad/sec measured at 190° C. of at least 8,000 Pa·s; preferably of at least 10,000 Pa·s; more preferably of at least 12,000 Pa·s.

For example, the initial polypropylene-containing material is selected to have a tan delta at 0.1 rad at 190° C. above 2.5 preferably above 4.0 or ranging from 2.5 to 15.0

For example, the initial polypropylene-containing material is selected to have a melt index MI₂ ranging from 0.1 to 20.0 g/10 min as determined according to ISO 1133-2011 at 230° C. under a load of 2.16 kg; an Mz above 1,000,000 g/mol as determined by size exclusion chromatography; an Mw/Mn ranging from 2.2 to 30.0 as determined by size exclusion chromatography; a complex viscosity at a frequency of 0.01 rad/sec measured at 190° C. of at least 8,000 Pa·s and preferably a tan delta at 0.1 rad at 190° C. above 2.5.

For example, the polypropylene in the initial polypropylene-containing material is selected from a propylene homopolymer, a random copolymer of propylene, a heterophasic copolymer of propylene, or a mixture thereof.

In an embodiment, the grafting agent comprises or consists of one or more functional monomers selected from maleic anhydride (MAH), glycidyl methacrylate (GMA), methyl methacrylate (MMA), acrylic acid (AAc), butyl acrylate (BA) vinyl acetate (VA), diethyl maleate (DEM), acrylamide (AAm), acrylonitrile (CAN), and any mixture thereof. With preference, the grafting agent is or comprises maleic anhydride (MAH).

For example, the grafting agent is provided in a content ranging from 0.1 to 10.0 wt. % or from 0.8 to 8.0 wt. % or from 1.0 to 6.0 wt. % or from 1.5 to 4.0 wt. % or from 2.0 to 5.0 wt. % based on the total weight of the polypropylene-containing material provided on step (b).

In an embodiment, the modified polypropylene composition recovered in step (e), and/or the modified polypropylene composition according to the second or the third aspect, has a melt index MI₂ ranging from 10.0 to 600.0 g/10 min as determined according to ISO 1133-2011 at 230° C. under a load of 2.16 kg.

In an embodiment, the modified polypropylene composition recovered in step (e) and/or the modified polypropylene composition according to the second or the third aspect has an Mw below 350,000 g/mol as determined by size exclusion chromatography; preferably, below 300,000 g/mol; preferably, below 250,000 g/mol; preferably, below 220,000 g/mol; preferably, below 200,000 g/mol.

In an embodiment, the modified polypropylene composition recovered in step (e) and/or the modified polypropylene composition according to the second or the third aspect has an Mw above 50,000 g/mol as determined by size exclusion chromatography; preferably, above 55,000 g/mol; preferably, above 60,000 g/mol; preferably, above 65,000 g/mol; preferably, above 80,000 g/mol.

In an embodiment, the modified polypropylene composition recovered in step (e) and/or the modified polypropylene composition according to the second or the third aspect has an Mn below 60,000 g/mol as determined by size exclusion chromatography; preferably, below 55,000 g/mol; preferably, below 50,000 g/mol.

In an embodiment, the modified polypropylene composition recovered in step (e) and/or the modified polypropylene composition according to the second or the third aspect has an Mn above 10,000 g/mol as determined by size exclusion chromatography; preferably, above 15,000 g/mol; preferably, above 20,000 g/mol.

In an embodiment, the modified polypropylene composition recovered in step (e) and/or the modified polypropylene composition according to the second or the third aspect has an Mz below 1,000,000 g/mol as determined by size exclusion chromatography; preferably, below 900,000 g/mol; preferably, below 800,000 g/mol; preferably, below 700,000 g/mol; preferably, below 600,000 g/mol; preferably, below 500,000 g/mol.

In an embodiment, the modified polypropylene composition recovered in step (e) and/or the modified polypropylene composition according to the second or the third aspect has a ratio of complex viscosity at a frequency of 0.01 rad/sec to the complex viscosity at a frequency of 100 rad/sec of at most 8.0 said ratio being measured at 190° C. In an embodiment, the modified polypropylene composition recovered in step (e) and/or the modified polypropylene composition according to the second or the third aspect has a tan delta at 0.1 rad at 190° C. above 2.5.

For example, the modified polypropylene composition recovered in step (e) and/or the modified polypropylene composition according to the second or the third aspect has a melt index MI₂ ranging from 10.0 to 600.0 g/10 min as determined according to ISO 1133-2011 at 230° C. under a load of 2.16 kg; an Mz below 1,000,000 g/mol as determined by size exclusion chromatography; a ratio of complex viscosity at a frequency of 0.01 rad/sec to the complex viscosity at a frequency of 100 rad/sec of at most 8.0 said ratio being measured at 190° C. and a tan delta at 0.1 rad at 190° C. above 2.5.

In an embodiment, the modified polypropylene composition recovered in step (e) and/or the modified polypropylene composition according to the second or the third aspect has a complex viscosity at 0.01 rad/sec at 190° C. ranging from 50 to 2,000 Pas; for example, ranging from 50 to 300 Pa's or ranging from 300 to 2,000 Pa·s.

In an embodiment, the modified polypropylene composition recovered in step (e) and/or the modified polypropylene composition according to the second or the third aspect has an Mz/Mw of at most 7.0 as determined by size exclusion chromatography; preferably at most 6.0; preferably at most 5.5; preferably at most 5.0; preferably at most 4.5; preferably at most 4.0; preferably at most 3.5; preferably at most 3.0; preferably at most 2.5.

For example, the modified polypropylene composition recovered in step (e) and/or the modified polypropylene composition according to the second or the third aspect has an Mz/Mw of at least 1.5 as determined by size exclusion chromatography; preferably at least 1.6; preferably at least 1.7; preferably at least 1.8; preferably at least 1.9; preferably at least 2.0.

For example, the modified polypropylene composition recovered in step (e) and/or the modified polypropylene composition according to the second or the third aspect has an Mz/Mw ranging from 1.5 to 7.0 as determined by size exclusion chromatography; preferably, ranging from 1.6 to 6.0; preferably, ranging from 1.7 to 5.0; preferably, ranging from 1.8 to 4.0; or from 1.7 to 3.5.

In an embodiment, the modified polypropylene composition recovered in step (e) and/or the modified polypropylene composition according to the second or the third aspect has an Mw/Mn of at most 10.0 as determined by size exclusion chromatography; preferably at most 9.0; preferably at most 8.0; preferably at most 7.0; preferably at most 6.0; preferably at most 5.0; preferably at most 4.5; preferably at most 4.0; preferably at most 3.5.

For example, the modified polypropylene composition recovered in step (e) and/or the modified polypropylene composition according to the second or the third aspect has an Mw/Mn of at least 2.2 as determined by size exclusion chromatography; preferably at least 2.3; preferably at least 2.4; preferably at least 2.5 preferably at least 2.8; preferably at least 3.0.

For example, the modified polypropylene composition recovered in step (e) and/or the modified polypropylene composition according to the second or the third aspect has an Mw/Mn ranging from 2.2 to 10.0 as determined by size exclusion chromatography; preferably, ranging from 2.3 to 8.0; preferably, ranging from 2.4 to 6.0; preferably, ranging from 2.5 to 5.5; or from 3.0 to 5.0.

For example, the modified polypropylene composition recovered in step (e) and/or the modified polypropylene composition according to the second or the third aspect has:
a melt index MI₂ ranging from 10.0 to 600.0 g/10 min as determined according to ISO 1133-2011 at 230° C. under a load of 2.16 kg;
an Mz below 1,000,000 g/mol as determined by size exclusion chromatography;
a ratio of complex viscosity at a frequency of 0.01 rad/sec to the complex viscosity at a frequency of 100 rad/sec of at most 8.0 said ratio being measured at 190° C.,
a tan delta at 0.1 rad at 190° C. above 2.5,
a complex viscosity at 0.01 rad/sec at 190° C. ranging from 50 to 2,000 Pas;
an Mw/Mn ranging from 2.2 to 10.0 as determined by size exclusion chromatography; and
an Mz/Mw ranging from 1.5 to 7.0 as determined by size exclusion chromatography.

For example, the maximum barrel temperature Ts is at least 320° C.; preferably at least 325° C.; preferably at least 330° C.; preferably at least 335° C. more preferably at least 340° C.; even more preferably at least 345° C.

For example, the maximum barrel temperature Ts is at least 345° C.; preferably at least 350° C. or at least 355° C.; preferably at least 360° C.; preferably at least 370° C. more preferably at least 380° C.; even more preferably at least 385° C. or at least 390° C.

For example, the maximum barrel temperature Ts is at most 440° C.; preferably at most 435° C.; preferably at most 430° C.; preferably at most 425° C.

For example, the maximum barrel temperature Ts is 345 to 440° C.; preferably, ranging from 345° C. to 430° C.; more preferably ranging from 350° C. to 425° C.; even more preferably, ranging from 360° C. to 420° C. and most preferably, ranging from 370° C. to 410° C. The maximum barrel temperature is the highest temperature amongst the imposed or measured temperatures along the extruder.

In an embodiment the maximum barrel temperature Ts is at least 385° C. or at least 390° C.; preferably at least 395° C.; preferably at least 400° C.; preferably at least 410° C. more preferably at least 415° C. For example, the maximum barrel temperature Ts is 390 to 440° C.; preferably, ranging from 390° C. to 430° C.; more preferably ranging from 395° C. to 425° C.; even more preferably, ranging from 400° C. to 420° C. and most preferably, ranging from 385° C. to 430° C.

In an alternative embodiment, the maximum barrel temperature Ts is less than 400° C. or at most 395° C.; preferably at most 390° C.; preferably at most 385° C.; preferably at most 380° C.; more preferably at most 375° C. For example, the maximum barrel temperature Ts is 345 to 395° C.; preferably, ranging from 350° C. to 390° C.; more preferably ranging from 360° C. to 385° C.; even more preferably, ranging from 345° C. to 380° C. and most preferably, ranging from 345° C. to 375° C.

In an embodiment, step (d) of extruding comprises a thermal treatment of the polypropylene-containing material at a maximum barrel temperature Ts ranging from 345° C. to 395° C. in one or more hot zones of the extruder and the modified polypropylene composition recovered in step (e) has a tan delta at 0.1 rad at 190° C. equal to or greater than 8.0.

In such an embodiment, the modified polypropylene composition recovered in step (e) and/or the modified polypropylene composition according to the second or the third aspect has a tan delta at 0.1 rad at 190° C. equal to or greater than 8.0; preferably, equal to or greater than 9.0; preferably, equal to or greater than 10.0; preferably, equal to or greater than 12.0; preferably, equal to or greater than 15.0; preferably, equal to or greater than 18.0; preferably, equal to or greater than 20.0; preferably, equal to or greater than 25.0.

For example, the maximum barrel temperature Ts ranging from 345° C. to 375° C. in one or more hot zones of the extruder and in that the modified polypropylene composition recovered in step (e) has a tan delta at 0.1 rad at 190° C. equal to or greater than 15.0.

In another embodiment, step (d) of extruding comprises a thermal treatment of the polypropylene-containing material at a maximum barrel temperature Ts ranging from 410 to 430° C. in one or more hot zones of the extruder and the modified polypropylene composition recovered in step (e) and/or the modified polypropylene composition according to the second or the third aspect:
has a tan delta at 0.1 rad at 190° C. that is equal to or below the tan delta of the polypropylene-containing material; and/or
a complex viscosity at 0.01 rad/sec at 190° C. ranging from 50 to 300 Pas; and/or
has a melt index (MI₂ T) that is at least 50 times higher than the melt index the polypropylene-containing material provided that the polypropylene-containing material is selected to have a melt index (MI₂ R) below 3.0 g/10 min as determined according to ISO 1133-2011 at 230° C. under a load of 2.16 kg.

According to a fifth aspect, the disclosure relates to the use of a polypropylene-containing material being a recycled polypropylene-containing material to produce a composite material; remarkable in that it comprises providing a recycled polypropylene-containing material comprising at least 50 wt. % of polypropylene based on the total weight of the recycled polypropylene-containing material; providing a grafting agent in a content ranging from 0.8 to 10.0 wt. % based on the total weight of the polypropylene-containing material, wherein the grafting agent comprises at least one double bound per molecule; extruding the recycled polypropylene-containing material and the grafting to obtain a modified polypropylene composition in an extruder with one or more thermal regulation devices; and then producing composite material from the modified polypropylene composition; wherein the extrusion comprises a thermal treatment of the recycled polypropylene-containing material at a maximum barrel temperature Ts of at least 345° C. in one or more hot zones of the extruder.

With preference, the thermal treatment of the recycled polypropylene-containing material at a maximum barrel temperature Ts of at least 345° C. in one or more hot zones of the extruder is performed by self-heating of the material wherein the extruder is a twin screw extruder and the one or more hot zones have a total length equal to or greater than 6 D with D being the screw diameter, wherein the extrusion is performed with mechanical specific energy greater than or equal to 0.30 kWh/kg, wherein, the screw profile comprises at least one hot zone with successive kneading blocks elements over a length of at least 4 D, with D being the screw diameter, followed by a left-handed element, wherein the thermal regulation devices, are set to initial imposed barrel temperatures ranging between 24° and 320° C., and are switched off when the barrel temperature in the zone spontaneously exceeds the imposed barrel temperature by at least 3° C. without the need of external heat application.

According to a sixth aspect, the disclosure relates to a composite material remarkable in that it comprises the polypropylene composition according to the second or the third aspect, and one or more filler selected from talc mineral filler, wollastonite, calcium carbonate, modified calcium carbonate, coated calcium carbonate, glass fibres, wood fibres, bamboo fibres, flax fibres, hemp fibres, carbon fibres, metal fibres, graphite fibres, silica fibres, silica-alumina fibres, alumina fibres, zirconia fibres, boron nitride fibres, silicon nitride fibres, boron fibres, potassium titanate whisker, aluminium borate whisker, magnesium-based whisker, silicon-based whisker, carbon black, carbon nanotubes, graphene nanotubes, and any mixture thereof.

With preference, the composite material is a wood-plastic composite comprising the modified polypropylene composition according to the second or the third aspect and wood fibers.

According to a seventh aspect, the disclosure relates to a multi-layered article remarkable in that it comprises at least one layer comprising the modified polypropylene composition according to the second or the third aspect and at least one barrier layer wherein the barrier layer comprises ethylene-vinyl alcohol copolymer or a metallic material selected from aluminium or stainless steel; with preference, the multi-layered article is selected from a pipe or a film or a food-packaging.

According to a eight aspect, the disclosure relates to a method to produce a composite material remarkable in that it comprises producing a modified polypropylene composition from a polypropylene-containing material according to the process according to the first aspect and producing a composite material using the modified polypropylene composition obtained by said process, (or using the polypropylene composition according to the second aspect); with preference, the polypropylene-containing material is a recycled polypropylene-containing material.

According to another aspect, the disclosure relates to a method to produce a composite material remarkable in that it comprises in a first step producing a modified polypropylene composition from a polypropylene-containing material according to the process as defined in the first aspect or providing a modified polypropylene composition according to the second or third aspect, and in a second step melt-blending the modified polypropylene composition with one or more fillers to produce a composite material further comprising one or more fillers; with preference, the polypropylene-containing material is a recycled polypropylene-containing material.

### DESCRIPTION OF THE FIGURES

FIGS. 1 and 2 are examples of a screw profile that can be used in the context of the disclosure

FIG. 3 is a graph plotting the complex viscosity to the angular frequency and further showing the loss (G″) and storage modulus (G′) for PP1.

FIG. 4 is a graph plotting the complex viscosity to the angular frequency and further showing the loss (G″) and storage modulus (G′) for the modified polypropylene composition obtained with extrusion at 400 rpm and a Ts of 320° C. of PP1.

FIG. 5 is a graph plotting the complex viscosity to the angular frequency and further showing the loss (G″) and storage modulus (G′) for the modified polypropylene composition obtained with extrusion at 400 rpm and a Ts of 360° C. of PP1.

FIG. 6 is a graph plotting the complex viscosity to the angular frequency and further showing the loss (G″) and storage modulus (G′) for the modified polypropylene composition obtained with extrusion at 400 rpm and a Ts of 390° C. of PP1.

FIG. 7 is a graph plotting the complex viscosity to the angular frequency and further showing the loss (G″) and storage modulus (G′) for the modified polypropylene composition obtained with extrusion at 400 rpm and a Ts of 420° C. of PP1.

FIG. 8 is a graph plotting the complex viscosity to the angular frequency and further showing the loss (G″) and storage modulus (G′) for the modified polypropylene composition obtained with extrusion at 400 rpm and a Ts of 450° C. of PP1.

FIG. 9 is a comparative graph plotting the complex viscosity to the angular frequency for the different samples.

FIG. 10 is a graph plotting the melt flow rate to the temperature Ts (i.e. the flash temperature) for the different samples.

FIG. 11 is a graph plotting the Mz to the temperature Ts (i.e. the flash temperature) for the different samples.

FIG. 12 is Van Gurp Palmen plot of different polypropylene compositions.

FIG. 13 shows the evolution of the activation energy flow as a function of the melt index for PP subjected to thermal treatment and to peroxide degradation.

### DETAILED DESCRIPTION

It is to be understood that this disclosure is not limited to particular processes or compositions described, as such processes or compositions may, of course, vary. It is also to be understood that the terminology used herein is not intended to be limiting since the scope of the present disclosure will be limited only by the appended claims.

When describing the polymers, uses and processes of the disclosure, the terms employed are to be construed by the following definitions, unless a context dictates otherwise. For the disclosure, the following definitions are given:

As used herein, the singular forms “a”, “an”, and “the” include both singular and plural referents unless the context dictates otherwise. By way of example, “a composition” means one composition or more than one composition.

The terms “comprising”, “comprises” and “comprised of as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all integer numbers and, where appropriate, fractions subsumed within that range (e.g., 1 to 5 can include 1, 2, 3, 4, 5 when referring to, for example, a number of elements, and can also include 1.5, 2, 2.75 and 3.80, when referring to, for example, measurements). The recitation of endpoints also includes the endpoint values themselves (e.g., from 1.0 to 5.0 includes both 1.0 and 5.0). Any numerical range recited herein is intended to include all sub-ranges subsumed therein.

All references cited in the present specification are hereby incorporated by reference in their entirety. In particular, the teachings of all references herein specifically referred to are incorporated by reference. Indication of a standard method to determine a parameter implies referring to the standard in force at the priority date of the application, in case the year of the standard is not indicated.

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the disclosure and form different embodiments, as would be understood by those in the art. For example, in the following claims and statements, any of the embodiments can be used in any combination.

Unless otherwise defined, all terms used in disclosing the disclosure, including technical and scientific terms, have the meaning as commonly understood by one of ordinary skill in the art to which this disclosure belongs. By means of further guidance, definitions for the terms used in the description are included to better appreciate the teaching of the present disclosure.

The terms “polypropylene” (PP) and “propylene polymer” may be used synonymously. The term “polypropylene” encompasses propylene homopolymer as well as propylene copolymer resin which can be derived from propylene and one or more comonomers selected from the group consisting of ethylene and C4-C20 alpha-olefins, such as 1-butene, 1-pentene, 4-methyl-1-pentene, 1-hexene, 1-octene, 1-decene, 1-dodecene, 1-tetradecene, 1-hexadecene, 1-octadecene and 1-eicosene.

The terms “polypropylene resin” or “propylene homopolymer resin” or “propylene copolymer resin” refer to polypropylene fluff or powder that is extruded, and/or melted and/or pelletized and can be produced through compounding and homogenizing of the polypropylene resin as taught herein, for instance, with mixing and/or extruder equipment. As used herein, the term “polypropylene” may be used as a shorthand for “polypropylene resin”. The terms “fluff” or “powder” refer to polypropylene material with the hard catalyst particle at the core of each grain and is defined as the polymer material after it exits the polymerization reactor (or the final polymerization reactor in the case of multiple reactors connected in series).

The terms “Post-Consumer Resin”, which may be abbreviated as “PCR”, is used to denote the components of domestic waste, household waste or end of life vehicle waste. In other words, the PCRs are made of recycled products from waste created by consumers. The terms “Post-Industrial Resin”, which may be abbreviated as “PIR”, is used to denote the waste components from pre-consumer resins during packaging processes. In other words, the PIRs are made of recycled products created from scrap by manufacturers.

The term “recycled modified polypropylene composition” or “recycled polypropylene-containing material” contrasts to the term “virgin modified polypropylene composition” “virgin polypropylene-containing material”, the term “virgin” is used to denote a modified polypropylene composition or material directly obtained from a polypropylene-containing polymerization plant. The terms “directly obtained” is meant to include that the modified polypropylene composition may optionally be passed through a pelletization step or an additivation step or both.

Under normal production conditions in a production plant, it is expected that the melt index (MI2, HLMI, MI5) will be different for the fluff than for the polypropylene-containing resin. Under normal production conditions in a production plant, it is expected that the density will be slightly different for the fluff than for the polypropylene-containing resin (if PCR resins are considered, it is not a question of fluff (powder) or pellets but it is a question of flakes or pellets). Unless otherwise indicated, density and melt index for the polypropylene-containing resin refer to the density and melt index as measured on the polypropylene-containing resin as defined above.

The present disclosure relates to a process for grafting a polypropylene-containing material to produce a modified polypropylene composition characterized in that it comprises the following steps:
a) providing a twin screw extruder with thermal regulation devices;
b) providing a polypropylene-containing material comprising at least 50 wt. % of polypropylene based on the total weight of the polypropylene-containing material;
c) providing a grafting agent in a content ranging from 0.8 to 10.0 wt. % based on the total weight of the polypropylene-containing material provided in step (b), wherein the grafting agent comprises at least one double bound per molecule;
d) extruding the polypropylene-containing material and the grafting agent to obtain a modified polypropylene composition; wherein said step comprises a thermal treatment of the polypropylene-containing material at a maximum barrel temperature Ts of at least 345° C. to at most 440° C. in one or more hot zones of the extruder with a residence time of less than 10 minutes; and
e) recovering a modified polypropylene composition;
   wherein the maximum barrel temperature Ts in step (d) is obtained by self-heating of the material wherein the one or more hot zones have a total length equal to or greater than 6 D with D being the screw diameter, wherein the extrusion is performed with mechanical specific energy greater than or equal to 0.30 kWh/kg, wherein the screw profile comprises at least one hot zone with successive kneading blocks elements over a length of at least 4 D followed by a left-handed element with D being the screw diameter, wherein the thermal regulation devices, are set to initial imposed barrel temperatures ranging between 24° and 320° C. and are switched off when the barrel temperature in the zone spontaneously exceeds the imposed barrel temperature by at least 3° C. without the need of external heat application.

The process of treating polypropylene-containing material involves increasing the melt index of the said polypropylene-containing material to produce a modified polypropylene composition with a melt index that is increased by a factor k of more than 6.0; preferably by a factor k of at least 7.0; preferably by a factor k of at least 8.0; preferably by a factor k of at least 10.0; preferably by a factor k of at least 15.0; preferably by a factor k of at least 20.0; preferably by a factor k of at least 30.0; preferably by a factor k of at least 35.0; preferably by a factor k of at least 40.0.

So that the ratio of the melt index of the modified polypropylene composition (MI₂ T) to the melt index of the polypropylene-containing material (MI₂ R) is more than 6.0; preferably of at least 7.0, preferably by at least 8.0; preferably at least 10.0; preferably at least 15.0; preferably at least 20.0; preferably at least 30.0; preferably at least 35.0; preferably at least 40.0.

It is observed that when using a specific screw design and so inducing strong thermomechanical degradation of the polymers, the relative melt index increase during the extrusion is less significant if the melt index of the starting material is already high.

The Extruder with One or More Thermal Regulation Devices and Step (d) of Extruding the Polypropylene-Containing Material to Obtain a Modified Polypropylene Composition

The treatment of the polypropylene-containing material to obtain a compatibilizer is performed by extrusion wherein step (d) of extruding comprises a thermal treatment of the polypropylene-containing material at a maximum barrel temperature Ts of at least 345° C. in one or more hot zones of the extruder; preferably wherein extrusion is performed with a residence time of less than 10 min.

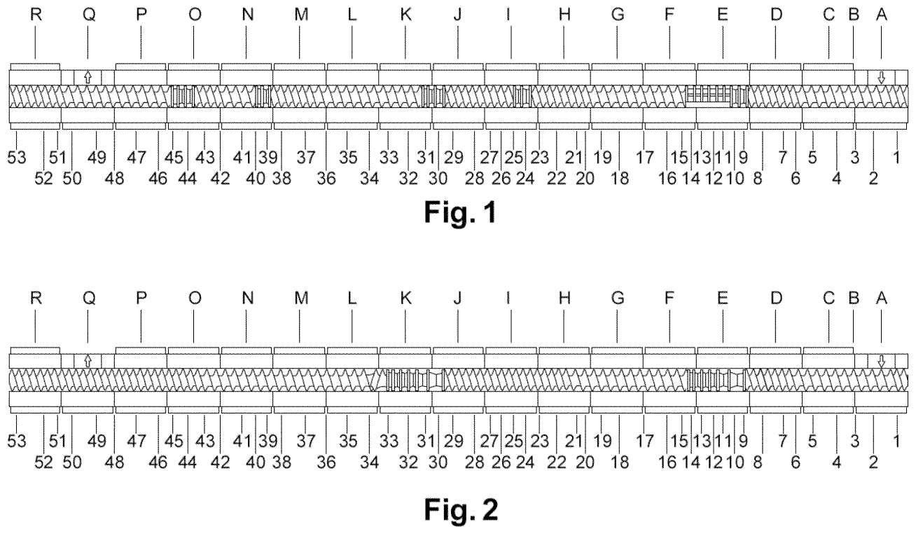

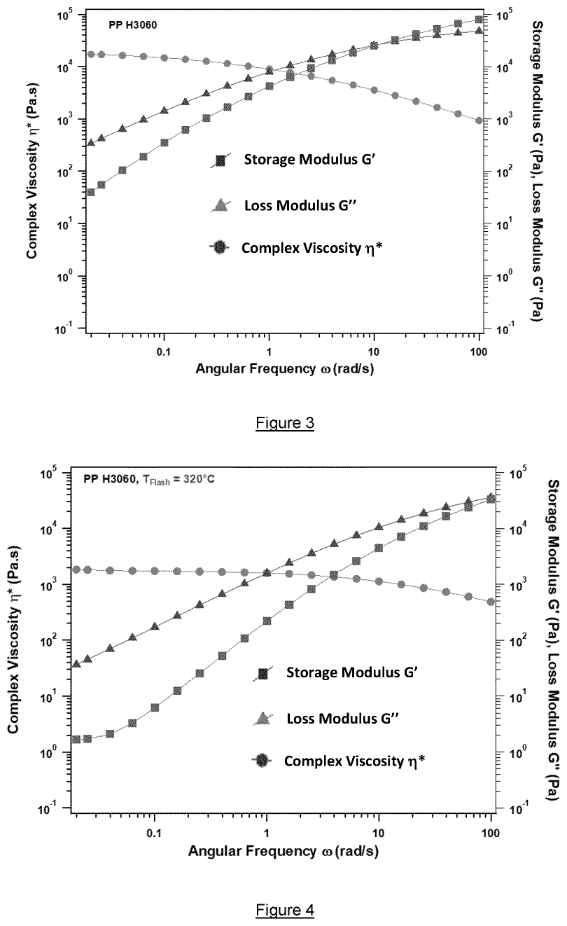

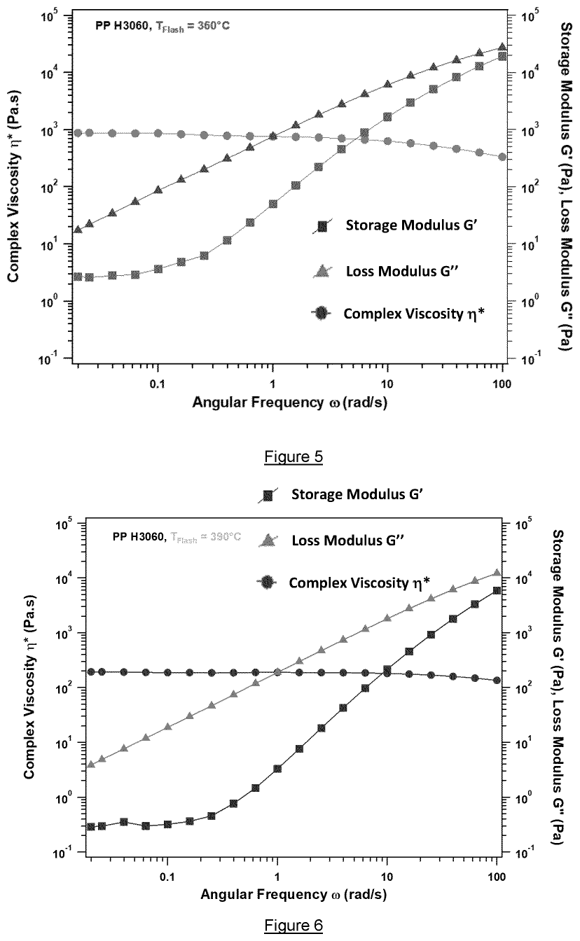

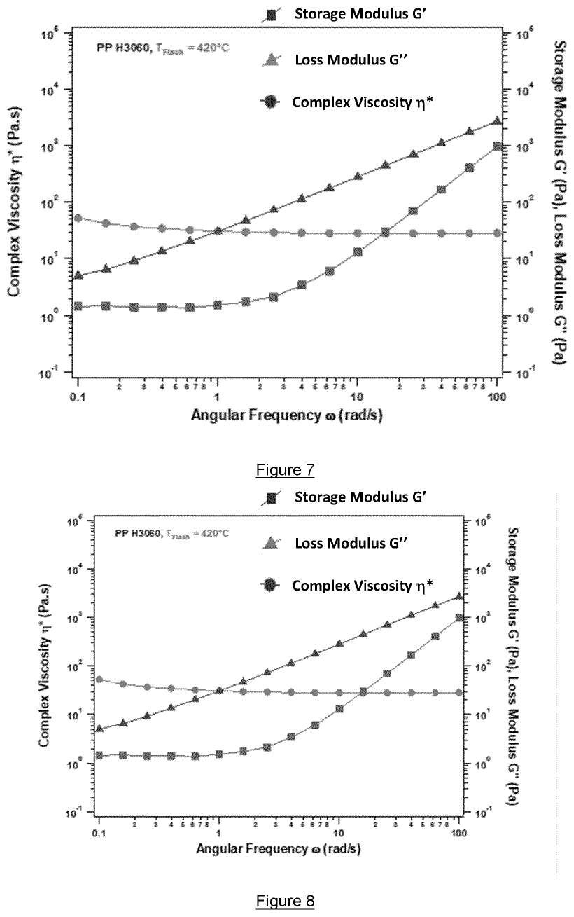

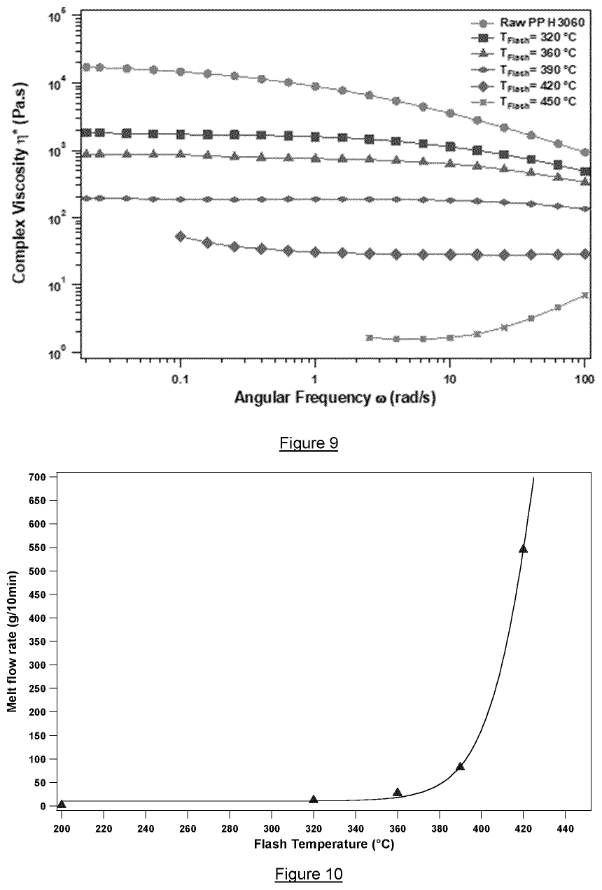

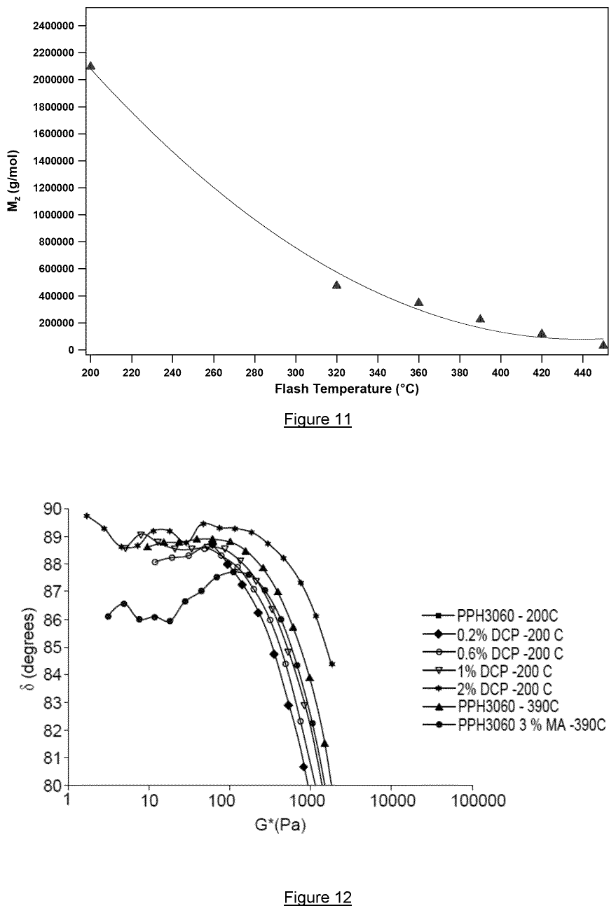

The extruder is a twin-screw extruder provided with a screw profile that shows an aggressive design, as shown in FIG. 1, to impart high mechanical energy to the polypropylene-containing material so the process comprises a thermal treatment by self-heating).

Thermal regulation devices can be used as a heating means to impart thermal energy to the polypropylene-containing material in the extruder, in addition to the thermal energy already generated by the mixing. In the present disclosure, the thermal regulation devices are only used to initiate the process and are switched off before the temperature Ts is reached.

Extrusion mixing varies with the type of screw and screw profile and is capable of significant generation of mechanical energy, such as shear energy and/or elongation energy. Therefore, energy is introduced into the extrusion process in terms of mechanical energy and thermal energy. Heating and/or cooling of the barrels can be achieved, for example, electrically, by steam, or by the circulation of thermally controlled liquids such as oil or water.

The extruder screw comprises a screw main body, that is composed of cylindrical elements and an axis of rotation supporting the elements. The axis of rotation extends straight from its basal end to its tip. In a state in which the extruder screw is rotatably inserted in the cylinder of the barrel, the basal end of the extruder screw is positioned on one end side of the barrel, on which the supply port is provided, and the tip of the extruder screw is positioned on the other end side of the barrel, on which the discharge port is provided.

Screw extruders have a modular system that allows different screw elements to be drawn into the central shaft to build a defined screw profile. The extruder screw may comprise one or more elements selected from conveying elements, kneading elements, right-handed (normal) screw elements, left-handed (inverse) screw elements and any combination thereof. The elements are arranged in a defined order from the basal end to the tips of the extruder screw and this order, as well as the type and number of elements involved, define the screw profile. Extruders and screw elements are commercially available for example at Leistritz.

According to the disclosure, the treatment of the polypropylene-containing material is handled by mechanical energy.

When high mechanical energy is requested, the extruder provided has a specific screw profile that is built to be “aggressive”, meaning that high mechanical energy will be imparted to the polypropylene-containing material. High mechanical energy will result in an increase in the temperature in the extruder as known to the person skilled in the art so the thermal treatment is performed by self-heating of the material. Self-heating of the material is achieved from viscous dissipation in a twin-screw extruder.

In such an embodiment, the twin-screw extruder is selected to comprise one or more hot zones, preferably being filled mixing zones, wherein the total length of the one or more hot zones is equal to or greater than 6 D with D being the screw diameter.

It is understood that in case the screw profile is selected to comprise a single hot zone, then the total length of the said hot zone is equal to or greater than 6 D with D being the screw diameter. In such a case, the hot zone is also the melting zone of the twin-screw extruder.

In case, the screw profile comprises two or more hot zones, then a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter. For example, the twin-screw extruder comprises two filled mixing zones wherein each of the filled mixing zones has a length equal to or greater than 4 D with D being the screw diameter. Preferably the first hot zone is or comprises the melting zone of the extruder.

Various mixing elements could be considered in the one or more hot zones but the most preferred ones do not drive any forward conveying (dispersive kneading blocks elements with disks offset by 90 degrees). Other disk offset angles could be considered (for example 30 degrees, 45 degrees, or 60 degrees) but 90 degrees is preferred. The preferred minimum width of the disk is 0.3 D.

Thus, preferably, the successive kneading block elements of at least one hot zone comprise disks with disks offset by 90 degrees and a disk width of at least 0.3 D wherein D is the screw diameter.

For example, the twin-screw extruder comprises more than two filled mixing zones wherein the total length of filled mixing zones is equal to or greater than 8 D with D being the screw diameter.

For example, the strong melting zone of the twin-screw extruder is made of successive mixing elements over a length of 4 D, with D being the screw diameter, followed by a left-handed element; preferably a full-flight left-handed element.

In a preferred embodiment, the thermal regulation devices of the twin-screw extruder allow cooling of the barrels and the process comprises switching off the thermal regulation devices when the barrel temperature in the zone spontaneously exceeds the imposed barrel temperature by at least 1° C. without the need of external heat application; preferably, by at least 2° C., preferably, by at least 3° C.; more preferably by at least 5° C.; even more preferably, by at least 8° C.; and most preferably, by at least 10° C.

Indeed, when starting extrusion, thermal regulation devices will be switched on, in particular in the melting zone to allow the material to melt. Then, when the polymer is self-heating the thermal regulation devices are switched off to allow the increase of the temperature inside the extruder.

High rotation screw speeds are preferred, but the precise value of a high rotation screw speed is “extruder diameter” dependent. For example, when considering a diameter D of 18 mm twin-screw extruder, high rotational screw speed is considered to be higher than 500 rpm, preferably higher than 800 rpm. For example, when considering a diameter D=58 mm twin-screw extruder, high rotational screw speed is considered to be higher than 250 rpm, preferably higher than 350 rpm.

Non-limiting examples of suitable extruder screws with specific screw profiles are illustrated in FIGS. 1 and 2.

Using the above-presented process, a venting unit at the end of the extruder is not mandatory. When the thermal treatment is performed by heating the material in an extruder selected from a single screw extruder or a twin-screw extruder, the extruder provided can show either an extruder screw with a standard screw profile or with a specific screw profile (i.e., for enhanced self-heating).

The maximum barrel temperature Ts was found to influence not only the melt index but also the rheology of the modified polypropylene composition.

For example, the maximum barrel temperature Ts is at least 320° C.; preferably at least 325° C.; preferably at least 330° C.; preferably at least 335° C. more preferably at least 340° C.; even more preferably at least 345° C. For example, the maximum barrel temperature Ts is at least 350° C.; preferably at least 355° C.; preferably at least 360° C.; preferably at least 365° C. more preferably at least 370° C.; even more preferably at least 380° C. and most preferably at least 390° C.

For example, the maximum barrel temperature Ts is at most 440° C.; preferably at most 435° C.; preferably at most 430° C.; preferably at most 425° C.

For example, the maximum barrel temperature Ts is 315 to 440° C.; preferably, ranging from 315° C. to 430° C.; more preferably ranging from 320° C. to 425° C.; even more preferably, ranging from 330° C. to 420° C. and most preferably, ranging from 340° C. to 410° C. The maximum barrel temperature is the highest temperature amongst the imposed or measured temperatures along the extruder.

In an embodiment the maximum barrel temperature Ts is at least 385° C. or at least 390° C.; preferably at least 395° C.; preferably at least 400° C.; preferably at least 410° C. more preferably at least 415° C. For example, the maximum barrel temperature Ts is 390 to 440° C.; preferably, ranging from 390° C. to 430° C.; more preferably ranging from 395° C. to 425° C.; even more preferably, ranging from 400° C. to 420° C. and most preferably, ranging from 310° C. to 430° C.

In an embodiment the maximum barrel temperature Ts is less than 400° C. or at most 395° C.; preferably at most 390° C.; preferably at most 385° C.; preferably at most 380° C.; more preferably at most 375° C. For example, the maximum barrel temperature Ts is 315 to 395° C.; preferably, ranging from 320° C. to 390° C.; more preferably ranging from 330° C. to 385° C.; even more preferably, ranging from 340° C. to 380° C. and most preferably, ranging from 345° C. to 375° C.

The extrusion conditions may be adapted by the person skilled in the art to impart sufficient energy to obtain a compatibilizer with a melt index (MI₂ T) in the targeted range.

Screw speed can be adapted in function of the targeted maximum barrel temperature Ts and of the capacity of the extruder. Higher screw speed allows for a higher increase in the polymer temperature. For example, the screw speed ranges from 100 to 1200 rpm; preferably from 110 rpm to 1200 rpm; more preferably from 150 rpm to 1100 rpm; even more preferably from 200 rpm to 1000 rpm; most preferably from 300 rpm to 900 rpm; and even most preferably from 320 to 800 rpm or from 350 to 1200 rpm.

In an 18 mm screw diameter twin-screw extruder, the preferred screw speed is higher than 500 rpm; in a 58 mm screw diameter twin-screw extruder, the preferred screw speed is higher than 250 rpm.

For example, step (d) of extruding the polypropylene-containing material comprises performing the extrusion with a residence time of less than 10 minutes, such as ranging from 10 seconds to less than 10 minutes; preferably with a residence time ranging from 15 seconds to 8 minutes; or with a residence time ranging from 20 seconds to 5 minutes; more preferably with a residence time ranging from 10 to 180 seconds or from 10 to 120 seconds or from 20 to 100 seconds or from 30 to 80 seconds.

For example, the extruder comprises one or more venting parts at the end of the extruder (before the die). Such venting parts, connected to a vacuum pump, allow removing at least a part of the unreacted grafting agent.

For example, the extruder is selected to have a surface treatment. For example, one or more elements of the extruder are made of CrVNb microalloyed steel. Extruders with surface treatments are commercially available from Leistritz.

### The Polypropylene-Containing Material and the Step b) of Providing a Polypropylene-Containing Material

The process according to the disclosure comprises step (b) of providing a polypropylene-containing material comprising at least 50 wt. % of polypropylene based on the total weight of the polypropylene-containing material.

The polypropylene-containing material can be a virgin polypropylene-containing material, a recycled polypropylene-containing material or a mixture of virgin and recycled polypropylene-containing materials. In some embodiments, the polypropylene-containing material is a recycled polypropylene-containing material. As used herein, the terms “recycled modified polypropylene composition” encompasses both Post-Consumer Resins (PCR) and Post-Industrial Resins (PIR).

Suitable polypropylene includes but is not limited to homopolymer of ethylene, copolymer of ethylene and a higher alpha-olefin comonomer. Thus, preferably, the polypropylene in the polypropylene-containing material is one or more polypropylene homopolymers, one or more polypropylene copolymers, and any mixture thereof.

The term “copolymer” refers to a polymer, which is made by linking two different types of monomers in the same polymer chain. Preferred comonomers are alpha-olefins having from 3 to 20 carbon atoms or from 3 to 10 carbon atoms. More preferred comonomers are selected from the group comprising propylene, butene-1, pentene-1, hexene-1, heptene-1, octene-1, nonene-1, decene-1 and any mixture thereof. Even more preferred comonomers are selected from the group comprising butene-1, hexene-1, octene-1 and any mixture thereof. The most preferred comonomer is hexene-1.

The term “homopolymer” refers to a polymer that is made by linking only one monomer in the absence of comonomers. Ethylene homopolymers are therefore essentially without any comonomer. By “essentially without” it is meant that no comonomer is intentionally added during the production of the polypropylene, but can nevertheless be present in up to 0.2 wt. %, preferably in up to 0.1 wt. % and most preferably in up to 0.05 wt. %, relative to the total weight of the polypropylene.

In an embodiment, the propylene polymer is a propylene copolymer. The propylene copolymer can be a random copolymer, a heterophasic copolymer, or a mixture thereof.

The random propylene copolymer comprises at least 0.1 wt % of one or more comonomers, preferably at least 1 wt %. The random propylene copolymer comprises up to 10 wt % of one or more comonomers and most preferably up to 6 wt %. Preferably, the random copolymer is a copolymer of propylene and ethylene.

The heterophasic copolymer of propylene comprises a dispersed phase, generally constituted by an elastomeric ethylene-propylene copolymer (for example EPR), distributed inside a semi-crystalline polypropylene matrix being a homopolymer of propylene or a random propylene copolymer.

With preference, the polypropylene is a homopolymer, a random copolymer of propylene and at least one comonomer or a mixture thereof. Preferably, the polypropylene is not and/or does not comprise a terpolymer.

The polypropylene-containing material is selected to comprise at least 50 wt. % of polypropylene based on the total weight of the polypropylene-containing material. With preference, the polypropylene-containing material is selected to comprise at least 55 wt. % of polypropylene based on the total weight of the polypropylene-containing material; preferably, at least 60 wt. %; preferably, at least 70 wt. %; preferably, at least 80 wt. %; preferably, at least 90 wt. %; preferably, at least 95 wt. %. In an embodiment, the polypropylene-containing material is virgin material and consists of polypropylene (i.e. comprises 100 wt. % of polypropylene).

In an embodiment, the polypropylene-containing material is a recycled polypropylene-containing material. Recycled polypropylene-containing material may contain one or more polymers different from polypropylene.

In an embodiment, and in particular wherein the polypropylene-containing material is a recycled polypropylene-containing material; the polypropylene-containing material comprises at least one polymer different from polypropylene in a content ranging from 0 to 50 wt. % based on the total weight of the polypropylene-containing material wherein at least one polymer different from polypropylene is selected from polyethylene (PE), polyacrylate, polypropylene terephthalate (PET), polystyrene (PS), polylactic acid (PLA).

For example, the polypropylene-containing material comprises at least one polymer different from polypropylene in a content ranging from 0 to 50 wt. % based on the total weight of the polypropylene-containing material wherein at least one polymer different from polypropylene is selected from polyethylene (PE), polyacrylate, polypropylene terephthalate (PET), polystyrene (PS), polylactic acid (PLA), and any mixture thereof.

With preference, the polypropylene-containing material comprises at least one polymer different from polypropylene in a content ranging from 0 to 40 wt. % based on the total weight of the polypropylene-containing material; preferably from 0.1 to 20 wt. %; more preferably from 0.2 to 10 wt. %; and even more preferably from 0.5 to 5 wt. %. The content of the at least one polymer different from polypropylene can be determined by ¹³C-NMR.

For example, PCR polypropylene classically contains a small part of polyethylene (such as less than 5 wt. %). The content of the polyethylene can be determined by ¹³C-NMR.

In an embodiment, the polypropylene-containing material is selected to have a melt index (MI₂ R) ranging from 0.1 to 20.0 g/10 min as determined according to ISO 1133-2011 at 230° C. under a load of 2.16 kg; preferably ranging from 0.1 to 15.0 g/10 min or from 0.2 to 10.0 g/10 min; more preferably ranging from 0.3 to 8.0 g/10 min, or from 0.4 to 6.0 g/10 min, or from 0.5 to 5.0 g/10 min; even more preferably ranging from 0.6 to 4.5 g/10 min of from 0.7 to 4.0 g/10 min, or from 0.8 to 3.0 g/10 min.

In an embodiment the polypropylene-containing material has a melt index (MI₂ R) of at least 0.10 g/10 min as determined according to ISO 1133-2011 at 230° C. under a load of 2.16 kg; preferably at least 0.15 g/10 min; more preferably at least 0.2 g/10 min, or at least 0.3 g/10 min or at least 0.4 g/10 min; even more preferably at least 0.5 g/10 min, or at least 0.6 g/10 min, or at least 0.2 g/10 min; most preferably at least 0.8 g/10 min and even most preferably at least 0.9 g/10 min, or at least 1.0 g/10 min.

In an embodiment the polypropylene-containing material has a melt index (MI₂ R) of at most 20.0 g/10 min as determined according to ISO 1133-2011 at 230° C. under a load of 2.16 kg; preferably at most 18.0 g/10 min or at most 15.0 g/10 min; more preferably at most 12.0 g/10 min, or at most 10.0 g/10 min; even more preferably at most 8.0 g/10 min or at most 6.0 g10 min; most preferably at most 5.0 g/10 min or at most 4.5 g/10 min; and even most preferably at most 4.0 g/10 min, or at most 3.5 g/10 min; or at most 3.0 g/10 min; or at most 2.5 g/10 min.

For example, the initial polypropylene-containing material is selected to have an Mz above 800,000 g/mol as determined by size exclusion chromatography; preferably above 1,000,000 g/mol; more preferably above 1,200.00 g/mol.

In some embodiments, the polypropylene-containing material has an Mz/Mw of at least 4.0 as determined by gel permeation chromatography; preferably, ranging from 4.0 to 50.0; preferably, from 5.0 to 25.0; preferably, from 6.0 to 20.0; preferably, from 7.0 to 15.0.

For example, the initial polypropylene-containing material is selected to have a complex viscosity at a frequency of 0.01 rad/sec measured at 190° C. of at least 8,000 Pa·s; preferably of at least 10,000 Pa·s; more preferably of at least 12,000 Pa·s.

In some embodiments, the polypropylene-containing material has a complex viscosity at 0.01 rad/sec at 190° C. of ranging from 10,000 to 80,000 Pa·s; preferably, ranging from 12,000 to 70,000 Pa·s; more preferably, ranging from 13,000 to 60,000 Pa·s; and even more preferably, ranging from 14,000 to 50,000 Pa·s.

In some embodiments, the polypropylene-containing material has an Mw/Mn ranging from 2.2 to 30.0 as determined by gel permeation chromatography; preferably ranging from 3.5 to 20.0; preferably ranging from 5.0 to 15.0.

In some embodiments, the polypropylene-containing material has a complex viscosity ratio above 10; preferably, a complex viscosity ratio of at least 11; more preferably, a complex viscosity ratio of at least 12.

### The Grafting Agent and Step (c) of Providing a Grafting Agent

The process according to the disclosure comprises step (c) of providing a grafting agent comprising at least one double bound per molecule. For example, the grafting agent comprises at least one vinyl group per molecule.

For example, the grafting agent comprises or consists of one or more functional monomers selected between from maleic anhydride (MAH), glycidyl methacrylate (GMA), methyl methacrylate (MMA), acrylic acid (AAc), butyl acrylate (BA) vinyl acetate (VA), diethyl maleate (DEM), acrylamide (AAm), acrylonitrile (CAN), and any mixture thereof. With preference, the grafting agent is or comprises maleic anhydride (MAH).

The grafting agent is provided in a content ranging from 0.1 to 10.0 wt. % or from 0.5 to 10.0 wt. % or from 0.8 to 10.0 wt. % based on the total weight of the polypropylene-containing material; preferably, from 0.9 to 8.0 wt. %; more preferably, from 1.0 to 6.0 wt. %; even more preferably, from 1.1 to 5.5 wt. %; most preferably, from 1.2 to 5.0 wt. %; even most preferably, from 1.3 to 4.5 wt. %; or from 1.5 to 4.0 wt. %; or from 2.0 to 5.0 wt. %.

For example, the grafting agent is provided in a content of at least 0.1 wt. % or at least 0.2 wt. % or at least 0.5 wt. % or at least 0.7 wt. % or at least 0.8 wt. % or at least 0.9 wt. % based on the total weight of the polypropylene-containing material; preferably, at least 1.0 wt. %; more preferably at least 1.1 wt. %; even more preferably at least 1.2 wt. %; most preferably at least 1.3 wt. % and even most preferably at least 1.5 wt. % or at least 1.8 wt. %; or at least 2.0 wt. %.

For example, the grafting agent is provided in a content of at most 10.0 wt. % or at most 8.0 wt. % based on the total weight of the polypropylene-containing material; preferably, at most 6.0 wt. %; more preferably, at most 5.5 wt. %; even more preferably at most 5.0 wt. %; most preferably at most 4.5 wt. % and even most preferably at most 4.0 wt. %.

The grafting agent is introduced in the extruder by the main hoper, for example via a specific dosing system, or via a lateral injection in the extruder; preferably, the grafting agent is introduced via the main hoper.

The step of providing a grafting agent may further comprise providing one or more additives in addition to the grafting agent. For example, one or more additives such as, by way of example, antioxidants, light stabilizers, acid scavengers, flame retardants, lubricants, antistatic additives, nucleating/clarifying agents, colourants, slip agents, anti-blocking agents, processing aids and any mixture thereof.

Although peroxides are not required, in an embodiment, the process further comprises providing one or more peroxides in addition to the grafting agent.

For example, the content of peroxide is at most 1000 ppm based on the total weight of the polypropylene-containing material; preferably at most 800 ppm; more preferably at most 500 ppm; even more preferably at most 200 ppm and most preferably at most 100 ppm.

For example, the content of peroxides is ranging from 0 to 1000 ppm based on the total weight of the polypropylene-containing material; preferably from 10 to 800 ppm; more preferably from 20 to 500 ppm, even more preferably from 30 to 250 ppm and most preferably from 50 to 100 ppm.

For example, the one or more peroxides are or comprise organic peroxides selected from the group consisting of diacetyl peroxide, cumyl-hydro-peroxide, dibenzoyl peroxide, dialkyl peroxide, 2,5-methyl-2,5-di(terbutylperoxy)-hexane, and combinations thereof.

In a preferred embodiment, the process is devoid of a step of providing one or more peroxides in addition to the grafting agent. In such an embodiment no peroxides are used so the content of peroxide is 0 ppm.

### The Modified Polypropylene Composition and the Step d) Recovering a Modified Polypropylene Composition

Step d) comprises recovering a modified polypropylene composition that is the grafted polypropylene-containing material.

For example, the modified polypropylene composition has a melt index (MI₂ T) ranging from 10.0 to In an embodiment, the modified polypropylene composition recovered in step (e), and/or the modified polypropylene composition according to the disclosure, has a melt index MI₂ ranging from 10.0 to 600.0 g/10 min as determined according to ISO 1133-2011 at 230° C. under a load of 2.16 kg.

For example, the polypropylene composition recovered in step (e), and/or the polypropylene composition obtained, has a melt index MI₂ of at least 10.0 g/10 min as determined according to ISO 1133-2011 at 230° C. under a load of 2.16 kg; preferably at least 11.0 g/10 min; more preferably, at least 15.0 g/10 min; even more preferably at least 20.0 g/10 min and most preferably at least 22.0 g/10 min.

For example, the polypropylene composition recovered in step (e), and/or the polypropylene composition obtained, has a melt index MI₂ of at most 600.0 g/10 min as determined according to ISO 1133-2011 at 230° C. under a load of 2.16 kg; preferably at most 500.0 g/10 min; more preferably, at most 400.0 g/10 min; even more preferably at most 300.0 g/10 min and most preferably at most 280.0 g/10 min.

For example, the grating agent is present in the modified polypropylene composition at a content ranging from 0.1 to 5.0 wt. % based on the total weight of the modified polypropylene composition; preferably from 0.2 to 4.0 wt. %; more preferably from 0.3 to 3.5 wt. %; even more preferably from 0.4 to 2.2 wt. %. It is understood that the grafting agent content represents the grafted content as determined by titration and does not include the unreacted grafting agent. In other words, the grafting agent content determination is performed after purification as described in the methods. Purification can include a venting procedure performed at the end of the extruder.

The modified polypropylene composition corresponds to the starting material that has been grafted and thermally treated to increase the melt index. However, surprisingly, the thermal treatment performed also provides other features to the modified polypropylene composition that makes it particularly suitable for injection molding or to produce compatibilizers.

In an embodiment, the modified polypropylene composition recovered in step (e) and/or the modified polypropylene composition according to the disclosure has an Mw below 350,000 g/mol as determined by size exclusion chromatography; preferably, below 300,000 g/mol; preferably, below 250,000 g/mol; preferably, below 220,000 g/mol; preferably, below 200,000 g/mol.

In an embodiment, the modified polypropylene composition recovered in step (e) and/or the modified polypropylene composition according to the disclosure has an Mw above 50,000 g/mol as determined by size exclusion chromatography; preferably, above 55,000 g/mol; preferably, above 60,000 g/mol; preferably, above 65,000 g/mol; preferably, above 80,000 g/mol.

In an embodiment, the modified polypropylene composition recovered in step (e) and/or the modified polypropylene composition according to the disclosure has an Mn below 60,000 g/mol as determined by size exclusion chromatography; preferably, below 55,000 g/mol; preferably, below 50,000 g/mol.

In an embodiment, the modified polypropylene composition recovered in step (e) and/or the modified polypropylene composition according to the disclosure has an Mn above 10,000 g/mol as determined by size exclusion chromatography; preferably, above 15,000 g/mol; preferably, above 20,000 g/mol.

In an embodiment, the modified polypropylene composition recovered in step (e) and/or the modified polypropylene composition according to the disclosure has an Mz below 1,000,000 g/mol as determined by size exclusion chromatography; preferably, below 900,000 g/mol; preferably, below 800,000 g/mol; preferably, below 700,000 g/mol; preferably, below 600,000 g/mol; preferably, below 500,000 g/mol.

In an embodiment, the modified polypropylene composition recovered in step (e) and/or the modified polypropylene composition according to the disclosure has a ratio of complex viscosity at a frequency of 0.01 rad/sec to the complex viscosity at a frequency of 100 rad/sec of at most 8.0 said ratio being measured at 190° C.

In an embodiment, the modified polypropylene composition recovered in step (e) and/or the modified polypropylene composition according to the disclosure has a tan delta at 0.1 rad at 190° C. above 2.5.

For example, the modified polypropylene composition recovered in step (e) and/or the modified polypropylene composition according to the disclosure has a melt index MI₂ ranging from 10.0 to 600.0 g/10 min as determined according to ISO 1133-2011 at 230° C. under a load of 2.16 kg; an Mz below 1,000,000 g/mol as determined by size exclusion chromatography; a ratio of complex viscosity at a frequency of 0.01 rad/sec to the complex viscosity at a frequency of 100 rad/sec of at most 8.0 said ratio being measured at 190° C. and a tan delta at 0.1 rad at 190° C. above 2.5.

In an embodiment, the modified polypropylene composition recovered in step (e) and/or the modified polypropylene composition according to the disclosure has a complex viscosity at 0.01 rad/sec at 190° C. ranging from 50 to 2,000 Pas; for example, ranging from 50 to 300 Pa·s or ranging from 300 to 2,000 Pa·s.

In an embodiment, the modified polypropylene composition recovered in step (e) and/or the modified polypropylene composition according to the disclosure has an Mz/Mw of at most 7.0 as determined by size exclusion chromatography; preferably at most 6.0; preferably at most 5.5; preferably at most 5.0; preferably at most 4.5; preferably at most 4.0; preferably at most 3.5; preferably at most 3.0; preferably at most 2.5.

For example, the modified polypropylene composition recovered in step (e) and/or the modified polypropylene composition according to disclosure has an Mz/Mw of at least 1.5 as determined by size exclusion chromatography; preferably at least 1.6; preferably at least 1.7; preferably at least 1.8; preferably at least 1.9; preferably at least 2.0.

For example, the modified polypropylene composition recovered in step (e) and/or the modified polypropylene composition according to the disclosure has an Mz/Mw ranging from 1.5 to 7.0 as determined by size exclusion chromatography; preferably, ranging from 1.6 to 6.0; preferably, ranging from 1.7 to 5.0; preferably, ranging from 1.8 to 4.0; or from 1.7 to 3.5.

In an embodiment, the modified polypropylene composition recovered in step (e) and/or the modified polypropylene composition according to the disclosure has an Mw/Mn of at most 10.0 as determined by size exclusion chromatography; preferably at most 9.0; preferably at most 8.0; preferably at most 7.0; preferably at most 6.0; preferably at most 5.0; preferably at most 4.5; preferably at most 4.0; preferably at most 3.5.

For example, the modified polypropylene composition recovered in step (e) and/or the modified polypropylene composition according to the second or the third aspect has an Mw/Mn of at least 2.2 as determined by size exclusion chromatography; preferably at least 2.3; preferably at least 2.4; preferably at least 2.5 preferably at least 2.8; preferably at least 3.0.

For example, the modified polypropylene composition recovered in step (e) and/or the modified polypropylene composition according to the disclosure has an Mw/Mn ranging from 2.2 to 10.0 as determined by size exclusion chromatography; preferably, ranging from 2.3 to 8.0; preferably, ranging from 2.4 to 6.0; preferably, ranging from 2.5 to 5.5; or from 3.0 to 5.0.

The polypropylene composition recovered in step (e) and/or the modified polypropylene composition according to the disclosure has an activation energy of flow (Ea) of at least 44.0 kJ/mol as determined according to the method of the description; preferably, of at least 45.0 kJ/mol or at least 46.0 kJ/mol; more preferably, of 47.0 kJ/mol or at least 48.0 kJ/mol; even more preferably, of at least 48.5 kJ/mol; most preferably, of at least 49.0 kJ/mol; even most preferably, of at least 49.5 kJ/mol or at least 50.0 kJ/mol or more than 50.0 kJ/mol, or at least 52.0 kJ/mol or at least 54.0 kJ/mol.

### The Composite Material

The disclosure also relates to a composite material and to a method to produce such a composite material.

The method to produce a composite material is remarkable in that it comprises producing a modified polypropylene composition from a polypropylene-containing material according to the above-described process, or providing a modified polypropylene composition according to the above definition and melt-blending the modified polypropylene composition with one or more fillers; with preference, the polypropylene-containing material is a recycled polypropylene-containing material. More preferably, the composite material is a wood-plastic composite comprising the modified polypropylene composition and wood fibres. Modified polypropylene may also be used as an intermediate layer in multi-layers structures like multi-layers films. Such devices are produced by lamination or directly in a film production machine equipped with a multilayer die (and of course with multiple extruders).

When used to compatibilise polar fillers with apolar matrixes, the one or more fillers are preferably selected from talc mineral filler, wollastonite, calcium carbonate, modified calcium carbonate, coated calcium carbonate, glass fibres, wood fibres, bamboo fibres, flax fibres, hemp fibres, carbon fibres, metal fibres, graphite fibres, silica fibres, silica-alumina fibres, alumina fibres, zirconia fibres, boron nitride fibres, silicon nitride fibres, boron fibres, potassium titanate whisker, aluminium borate whisker, magnesium-based whisker, silicon-based whisker, carbon black, carbon nanotubes, graphene nanotubes, and any mixture thereof; with preference, one or more fillers are selected from talc mineral filler, wollastonite, calcium carbonate, modified calcium carbonate, coated calcium carbonate, glass fibres, wood fibres, bamboo fibres, flax fibres, hemp fibres, carbon black, carbon nanotubes, graphene nanotubes, and any mixture thereof. More preferably, one or more fillers are selected from, glass fibres, wood fibres, bamboo fibres, flax fibres, hemp fibres, and any mixture thereof. Even more preferably, one or more fillers are wood fibres and/or glass fibres.

The content of the one or more fillers ranges from 0 to 60 wt. % as based on the total weight of the composite material; preferably from 0.1 to 50.0 wt. %, more preferably from 0.2 wt. % to 40.0 wt. %, even more preferably from 0.5 wt. % to 30.0 wt. %, most preferably from 1.0 wt. % to 20 wt. %, even most preferably from 1 wt. % to 15.0 wt. %, or from 1 wt. % to 12.5 wt. %, or from 1.0 wt. % to 5 wt. %.

The content of the modified polypropylene composition may be at most 10 wt. % as based on the total weight of the composite material; preferably at most 8.0 wt. %; more preferably at most 5.0 wt. %; even more preferably at most 3.0 wt. % and most preferably at most 2.0 wt. %.

For example, the composite material comprises from 0.1 to 60 wt. % of one or more fillers, and from 0.5 to 10 wt. % of modified polypropylene composition, the remaining being polypropylene; for example, the polypropylene-containing material and preferably recycled polypropylene-containing material.

In an embodiment, the composite material comprises at least 0.1 wt. % of one or more fillers, based on the total weight of the composite material, preferably at least 0.5 wt. %, more preferably at least 1.0 wt. %.

With preference, the composite material comprises at most 40.0 wt. % of one or more fillers, as based on the total weight of the composite material, preferably at most 30 wt. %, more preferably at most 20 wt. %, even more preferably at most 15 wt. %, most preferably at most 12.5 wt. % or at most 5 wt. %.

The disclosure also relates to multi-layered article remarkable in that it comprises at least one layer comprising the modified polypropylene composition and at least one barrier layer. For example, the barrier layer may be an organic polymer capable of providing the desired barrier properties, such as an ethylene-vinyl alcohol copolymer (EVOH), or a metal, for example, aluminum or stainless steel.

When used in multilayers structures, the modified polypropylene layer thickness is usually ranging between 1 and 50 μm, preferably between 5 and 25 μm.

For example, the multi-layered article characterized in that it comprises at least one layer comprising the modified polypropylene composition according to the present disclosure and at least one barrier layer wherein the barrier layer comprises ethylene-vinyl alcohol copolymer or a metallic material selected from aluminium or stainless steel; with preference, the multi-layered article is selected from a pipe or a film or a food-packaging.

### Test Methods

The melt flow index MI₂ of the polypropylene is determined according to ISO 1133-2011 at 230° C. under a load of 2.16 kg.

Molecular weights are determined by Size Exclusion Chromatography (SEC) at high temperatures (145° C.). A 10 mg polypropylene sample is dissolved at 160° C. in 10 mL of trichlorobenzene (technical grade) for 1 hour. Analytical conditions for the GPC-IR from Polymer Char are:
Injection volume: +/−0.4 mL;
Automatic sample preparation and injector temperature: 160° C.;
Column temperature: 145° C.;
Detector temperature: 160° C.;
Column set: 2 Shodex AT-806 MS and 1 Styragel HT6E;
Flow rate: 1 mL/min;
Eluent: trichlorobenzene
Detector: IR5 Infrared detector (2800-3000 cm-1);
Calibration: Narrow standards of polystyrene (commercially available);
Calculation for polypropylene: Based on Mark-Houwink relation (log₁₀ (M_{PP})=log₁₀ (M_{PS})-0.25323); cut off on the low molecular weight end at M_{PP}=1000;

The molecular weight averages used in establishing molecular weight/property relationships are the number average (Mₙ), weight average (M_{w}) and z average (M_{z}) molecular weight. These averages are defined by the following expressions and are determined from the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {M}_{i}} = \frac{{\sum }_{i} {h}_{i} {M}_{i}}{{\sum }_{i} {M}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mi. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well-known to the skilled person and include, for example, sufficient relaxation time etc. In practice, the intensity of a signal is obtained from its integral, i.e., the corresponding area. The data are acquired using proton decoupling, 2000 to 4000 scans per spectrum with 10 mm room temperature through or 240 scans per spectrum with a 10 mm cryoprobe, a pulse repetition delay of 11 seconds, and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenize the sample, followed by the addition of hexadeuterobenzene (C₆D₆, spectroscopic grade) and a minor amount of hexamethyldisiloxane (HMDS, 99.5+%), with HMDS serving as an internal standard. To give an example, about 200 mg to 600 mg of polymer is dissolved in 2.0 mL of TCB, followed by the addition of 0.5 mL of C6De and 2 to 3 drops of HMDS.

Following data acquisition, the chemical shifts are referenced to the signal of the internal standard HMDS, which is assigned a value of 2.03 ppm.

Complex shear modulus and viscosity: The complex shear modulus G*(w)=G′(w)+jG″(w) (J²=−1, G′(w): storage modulus and G″ (w): loss modulus) was determined using a DHR-2, a stress-controlled rheometer from TA Instruments. Frequency sweeps have been carried out in the linear domain (1% strain) at 190° C. from 100 to 0.01 rad·s⁻¹ under nitrogen flow to prevent thermaloxidative degradation. The used geometry was 25 mm diameter parallel plates with a 2 mm gap. The samples (25 mm diameter, 2 mm thickness) for these experiments were obtained beforehand using an injection press (Babyplast type). The complex viscosity η*(ω) is calculated according to the following equation of the linear viscoelasticity:

$$\vert {η}^{*} ( ω ) \vert = {[ {( \frac{{G}^{′} ( ω )}{ω} )}^{2} + {( \frac{{G}^{″} ( ω )}{ω} )}^{2} ]}^{1 / 2}$$

Tan delta is calculated from the loss modulus (G″) being divided by the storage modulus (G′) both determined at 0.1 rads and at 190° C.

### Determination of the MA Content (Titration)

Few grams of the grafted product are purified in a vacuum oven at 140° C. for 24 h, this step is crucial to remove all of the unreacted maleic acid by evaporation beyond the melting temperature of the polymer. This step is not needed when a venting procedure is performed at the end of the extruder.

The grafted maleic anhydride reacts with water hence forming the maleic acid form (diacid) which is optically active due to the presence of one asymmetric carbon in its molecule.

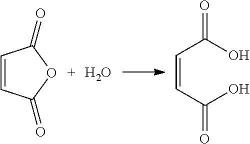

### Hydrolysis of Maleic Anhydride to Form Maleic Acid

The MA content of the purified products is calculated from the acid number. 0.5 g of the grafted polymer with maleic anhydride are dissolved in xylene at 120° C. in a flask with high agitation for 30 min. Then water drops are added to the solution after lowering the temperature to c.a. 100° C. The hot solution is then titrated immediately with ethanolic 0.05N KOH using three to four drops of 1% thymol blue in DMF indicator, the equivalence is observed when the solution turns from clear yellow to blue. A 0.5-1.0 mL excess of KOH solution is added, and the deep blue color was back-titrated to yellow end point by the addition of 0.05N isopropanolic HCl to the hot solution. The ethanolic KOH solution is previously standardized against a solution of known concentration of potassium hydrogen phthalate in water using phenolphthalein indicator.

The acid number and the maleic anhydride content were calculated as follows:

$$Acid Number ( mg KOH / g ) = \frac{{V}_{eq} \times {N}_{KOH} \times 56 , 1}{{m}_{polymer - g - MA}}$$

$$MA ( \% ) = \frac{acid number \times 98}{2 \times 561}$$

The grafted MA content is classified into 4 categories:
Low: 0.2-0.5%
Medium: 0.5-0.8%
High: 0.8-1%
Very high: above 1% (1-1.5%)
Ultra high: above 1.5%

### Flow Activation Energy (Ea) Measurement

The bulk dynamic rheological properties (e.g., G′, G″ and η*) of the polypropylene composition were measured at 210° C., 230° C. and 250° C. At each temperature, scans were performed as a function of angular shear frequency (from 300 to 0.1 rad/s) at a constant shears strain appropriately determined by the above procedure.

The dynamic rheological data was then analysed using the Rheometrics Software. The following conditions were selected for the time temperature (t-T) superposition and the determination of the flow activation energies (Ea) according to Arrhenius equation:

a_{T}=exp(Ea/kT), which relates the shift factor(a_{T}) to Ea:
Rheological Parameters: G′(ω), G″(ω) and η*(ω)
Reference temperature: 230° C.
Shift mode: 2D (i.e., horizontal and vertical shifts)
Shift Accuracy: High
Interpolation Mode: Spline

### EXAMPLES

The following non-limiting examples illustrate the disclosure

### Example 1—Influence of the Thermal Treatment on PP

PP1=PPH3060 commercialised by TotalEnergies. The MI₂ is determined according to ISO 1133-2011 (230° C., 2.16 kg) is 1.8 g/10 min.

PP1 was elected as, from a melt index point of view, it is representative of the melt index of the recycled polypropylene flux.

### The Screw Profile P1

The products were obtained by twin screw extrusion using a co-rotating extruder from Leistritz ZSE18 MAXX/HPe 68D (cylinder diameter=18 mm) with 1200 rpm as the maximum speed. This extruder includes 17 heating/cooling (ZIK) zones (excluding the die) that withstand a maximum temperature of 450° C. The feeding was exclusively made in the feeding zone and was made by gravimetry. The diameter of the die is 3 mm.

The screw profile P1 is illustrated in FIG. 1 and is composed of four major segments:

The first segment is the one of the feeding zones, composed of successive conveying elements. The second segment is composed of progressive high shear screw elements successive kneading block elements with disks offset by 30 degrees, 60 degrees, and 90 degrees and a disk width of at least 0.3 D wherein D is the screw diameter. The third segment consists of alternating conveying screw elements and kneading block elements. The third segment comprises the hot zone of the extruder.

The fourth and last segment consists of conveying elements and the die.

The temperature profile starts with a low temperature in the feeding zone (65° C.) and is increased progressively to 250° C. in the second segment (blending-fusion segment, Z3-Z5). Then the temperature is increased progressively in Z6-Z7 (300 and 320° C. respectively) to reach the high-temperature Tₛ fixed in the zones Z8-Z12. Afterwards, the temperature is lowered progressively until it reaches 200° C. in Z17 and the die to cool the melt. The one or more hot zones of the extruder are hence aimed in the zones Z8-Z12.

The screw profile P1

| No. element | mm | Leistritz name |
|---|---|---|
| 1 | 30 | GFA-2-20-30 |
| 2 | 60 | GFF-2-30-30-A |
| 3 | 90 | GFF-2-30-30-A |
| 4 | 120 | GFF-2-30-30-A |
| 5 | 150 | GFA-2-30-30 |
| 6 | 165 | GFA-2-30-15 |
| 7 | 195 | GFA-2-20-30 |
| 8 | 225 | GFA-2-20-30 |
| 9 | 240 | KB 4-2-15-30°-Re |
| 10 | 255 | KB 4-2-15-30°-Re |
| 11 | 270 | KB 4-2-15-60°-Re |
| 12 | 285 | KB 4-2-15-60°-Re |
| 13 | 300 | KB 4-2-15-90° |
| 14 | 315 | KB 4-2-15-90° |
| 15 | 330 | GFA-2-20-15 |
| 16 | 360 | GFA-2-30-30 |
| 17 | 390 | GFA-2-30-30 |
| 18 | 420 | GFA-2-30-30 |
| 19 | 450 | GFA-2-30-30 |
| 20 | 465 | GFA-2-20-15 |
| 21 | 480 | GFA-2-20-15 |
| 22 | 510 | GFA-2-20-30 |
| 23 | 540 | GFA-2-20-30 |
| 24 | 555 | KB 4-2-15-30°-Re |
| 25 | 570 | KB 4-2-15-60°-Re |
| 26 | 585 | GFA-2-20-15 |
| 27 | 600 | GFA-2-20-15 |
| 28 | 630 | GFA-2-20-30 |
| 29 | 660 | GFA-2-20-30 |
| 30 | 675 | KB 4-2-15-60°-Re |
| 31 | 690 | KB 4-2-15-90° |
| 32 | 720 | GFA-2-30-30 |
| 33 | 750 | GFA-2-30-30 |
| 34 | 780 | GFA-2-30-30 |
| 35 | 810 | GFA-2-30-30 |
| 36 | 840 | GFA-2-20-30 |
| 37 | 870 | GFA-2-20-30 |
| 38 | 900 | GFA-2-20-30 |
| 39 | 915 | KB 4-2-15-30°-Re |
| 40 | 930 | KB 4-2-15-60°-Re |
| 41 | 960 | GFA-2-30-30 |
| 42 | 990 | GFA-2-20-30 |
| 43 | 1020 | GFA-2-20-30 |
| 44 | 1035 | KB 4-2-15-60°-Re |
| 45 | 1050 | KB 4-2-15-60°-Re |
| 46 | 1080 | GFA-2-30-30 |
| 47 | 1110 | GFA-2-30-30 |
| 48 | 1140 | GFA-2-30-30 |
| 49 | 1170 | GFA-2-30-30 |
| 50 | 1200 | GFA-2-30-30 |
| 51 | 1215 | GFA-2-20-15 |
| 52 | 1245 | GFA-2-20-30 |
| 53 | 1275 | GFA-2-20-30 |

The barrel configuration

| No. element | mm | Leistritz name |
|---|---|---|
| A | 75 | Zyl-E |
| B | 76 | Wärmesperre |
| C | 151 | Zyl-0/MC |
| D | 226 | Zyl-0/MC |
| E | 301 | Zyl-0/MC |
| F | 376 | Zyl-0/MC |
| G | 451 | Zyl-0/MC |
| H | 526 | Zyl-0/MC |
| I | 601 | Zyl-0/MC |
| J | 676 | Zyl-0/MC |
| K | 751 | Zyl-0/MC |
| L | 826 | Zyl-0/MC |
| M | 901 | Zyl-0/MC |
| N | 976 | Zyl-0/MC |
| O | 1051 | Zyl-0/MC |
| P | 1126 | Zyl-0/MC |
| Q | 1201 | Zyl-1/MC |
| R | 1276 | Zyl-0/MC |

The products were obtained by twin screw extrusion using a co-rotating extruder from Leistritz ZSE18 MAXX/HPe 68D (cylinder diameter=18 mm) with 1200 rpm as the maximum speed. This extruder includes 17 heating/cooling (ZIK) zones (excluding the die) that withstand a maximum temperature of 450° C. The feeding was exclusively made in the feeding zone and was made by gravimetry. The diameter of the die is 3 mm.

The polymer joint is driven in a cooling water bath of 2.5 m tall that ends with an airflow drying system before entering the pelletizer. The extruder is equipped with 3 efficient fume extraction arms.

The Extrusion with Thermal Treatment

5 samples MAT152 to MAT156 have been processed under the inventive process to attain a given T flash temperature ranging from 320 to 450° C.

TABLE 1
Extrusion outlooks

| | | | | | | | | | Motor |
|---|---|---|---|---|---|---|---|---|---|
| | | Flow | Screw | | | | | | specific |
| | T_{flash} | rate | speed | Torque | P1 | P2 | Tm1 | Tm2 | energy |
| Sample | (° C.) | (kg/h) | (rpm) | (%) | (bar) | (bar) | (° C.) | (° C.) | (kWh/kg) |
| MAT152 | 320 | 3 | 400 | 37 | 13 | 3 | 211 | 323 | 0.275 |
| MAT153 | 360 | 3 | 400 | 32 | 10 | 3 | 213 | 366 | 0.236 |
| MAT154 | 390 | 3 | 400 | 27 | 7 | 3 | 207 | 396 | 0.221 |
| MAT155 | 420 | 3 | 400 | 23 | 4 | 3 | 208 | 427 | 0.194 |
| MAT156 | 450 | 3 | 400 | 8 | 3 | 3 | 208 | 452 | 0.1 |

All samples could be granulated after cooling but MAT156 (450° C.) which was a wax like resin.

It is observed that the measured pressure at the die (P1) decreased with the Temperature of the flash extrusion zone. This is evidence of a decrease in the melt viscosity due to thermal degradation.

The results on the properties of the products are provided in Table 2

| | | | | | | | eta 0.1 | |
|---|---|---|---|---|---|---|---|---|
| Sample | Mn | Mw | Mz | | | MI2 | rad/s | T Flash |
| Designation | (g/mol) | (g/mol) | (g/mol) | Mw/Mn | Mz/Mw | (g/10 min) | (Pa/s) | (° C.) |
| PPH3060 | 65,163 | 464,146 | 2,097,916 | 7.1 | 4.5 | 1.72 | 14,647 | — |
| MAT152 | 49,888 | 199,375 | 474,785 | 4.0 | 2.4 | 12.1 | 1,719.4 | 320 |
| MAT153 | 46,815 | 162,439 | 347,683 | 3.5 | 2.1 | 27.4 | 859.6 | 360 |
| MAT154 | 39,001 | 116,285 | 225,273 | 3.0 | 1.9 | 82 | 187.09 | 390 |
| MAT155 | 26,499 | 66,636 | 117,635 | 2.5 | 1.8 | 545 | 52.49 | 420 |
| MAT156 | 8,880 | 18,481 | 30,849 | 2.1 | 1.7 | >500 | 5.59 | 450 |

### Example 2—Preparation of the Inventive Compatibilizers

For the jointed grafting and thermal treatment process the same PP and the same screw design as in example 1 were used.

PP1=PPH3060 commercialised by TotalEnergies. The MI₂ is determined according to ISO 1133-2011 (230° C., 2.16 kg) is 1.8 g/10 min.

### The Maleic Anhydride

MA1=is a commercial maleic anhydride provided by sigma Aldrich (Merck) and received in flake forms. It is micronized and used directly in the process. Maleic anhydride rapidly hydrolyzes to form maleic acid in the presence of water.

TABLE 2
Characteristics and properties of maleic anhydride.

| | |
|---|---|
| Preferred name | Furan-2,5-dione |
| CAS Number | 108-31-6 |
| Molar Mass (g/mol) | 98.06 |
| Formula | C2H2(CO)2O |
| Melting point (° C.) | 52.8 |
| Boiling point (° C.) | 202 |
| Appearance | White crystals or needles, flakes/powder |
| Density (g/cm³) | 1.48 |
| Structure | 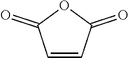 |

A blend comprising 3 wt. % of maleic anhydride and 97 wt. % of polypropylene PP1 was introduced in the twin-screw extruder with the screw profile P1.

The extrusion was performed with a Ts of 390° C. at 400 rpm. The residence time was less than 2 minutes. The resulting modified polypropylene composition showed a grafted MA content of 0.3 wt. % and an MI₂ of 82 g/10 min.

Van Gurp Palmen plot has been performed for MAT154 and compared to products obtained via peroxide degradation using different content of DCP as peroxide wherein the peroxide degradation was performed at 200° C. FIG. 12 illustrates the comparison, it can be seen that similar behaviour is obtained.

### Example 3—Activation Energy of Flow

Comparative tests with between polypropylene compositions obtained by thermal treatment and polypropylene composition obtained by peroxide degradation.

All experiments were performed starting from an industrial PPC2660 grade containing:
2000 ppm Irganox 1010,
400 ppm calcium stearate

Two types of extrusions were considered
Therm CR-PP production: The screw profile used contained three sequences of mixing elements followed by a left-handed element. Combining the use of such screw design in the Leistritz ZSE 18HPe (L/D=40-MPO-laboratory)) with high screw rotation speeds and a switch-off of the temperature regulation in the central zone of the extruder, important self-heating of the polymer could be induced, generating the free radicals. Change of the parameters associated to the self-heating (mainly the screw rotation speed) allows to target several melt indexes.
Perox CR-PP production: Using a classical screw profile. Various extrusions were performed with various Trigonox 101 (2,5-Dimethyl-2,5-di(tert-butylperoxy) hexane) content. The peroxide content has been adjusted to produce grades with MFI similar to those of the produced Therm CR-PP. This has been done considering preliminary extrusions and the dependence of the melt index as a function of the peroxide content.

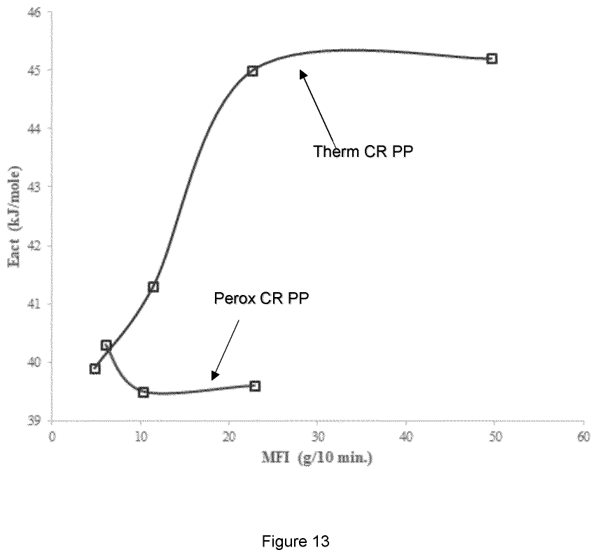

The melt index and the activation energy of flow were determined for the different samples and reported in FIG. 13 and Table 4

TABLE 4

| Sample | MFI (g/10 min) | Ea (KJ/mole) |
|---|---|---|
| Base Polymer (PPC 2660) | 0.94 | — |
| Therm CR-PP 5 | 4.74 | 39.9 |
| Therm CR-PP 10 | 11.4 | 41.3 |
| Therm CR-PP 22 | 22.6 | 45.0 |
| Therm CR-PP 46 | 49.5 | 45.2 |
| Perox CR-PP - 350 ppm T101 | 6.1 | 40.3 |
| Perox CR-PP - 550 ppm T101 | 10.3 | 39.5 |
| Perox CR-PP - 900 ppm T101 | 22.9 | 36.6 |

From the results it can be seen that higher activation energy of flow is shown by the polypropylene produced by thermal treatment by comparison to those obtained by peroxide degradation of similar melt index.

For modified compositions, the activation energy is increased for both compositions produced by thermal treatment and by peroxide degradation. However the polypropylene produced by thermal treatment will still show higher activation energy of flow by comparison to those obtained by peroxide degradation of similar melt index.

1. A process for grafting a polypropylene-containing material to produce a modified polypropylene composition characterized in that it comprises the following steps:
a) providing an extruder with thermal regulation devices;
b) providing a polypropylene-containing material comprising at least 50 wt. % of polypropylene based on the total weight of the polypropylene-containing material;
c) providing a grafting agent in a content ranging from 0.8 to 10.0 wt. % based on the total weight of the polypropylene-containing material provided in step (b), wherein the grafting agent comprises at least one double bound per molecule;
d) extruding the polypropylene-containing material and the grafting agent to obtain a modified polypropylene composition; wherein said step comprises a thermal treatment of the polypropylene-containing material at a maximum barrel temperature Ts of at least 345° C. to at most 440° C. in one or more hot zones of the extruder with a residence time of less than 10 minutes; and
e) recovering a modified polypropylene composition;
wherein the maximum barrel temperature Ts in step (d) is obtained by self-heating of the material wherein the one or more hot zones have a total length equal to or greater than 6 D with D being the screw diameter, wherein the extrusion is performed with mechanical specific energy greater than or equal to 0.30 kWh/kg, wherein the screw profile comprises at least one hot zone with successive kneading blocks elements over a length of at least 4 D followed by a left-handed element with D being the screw diameter, wherein the thermal regulation devices, are set to initial imposed barrel temperatures ranging between 24° and 320° C. and are switched off when the barrel temperature in the zone spontaneously exceeds the imposed barrel temperature by at least 3° C. without the need of external heat application.

2. The process according to claim 1 is characterised in that the thermal treatment is performed by self-heating of the material in a twin screw extruder, and in that the screw profile comprises two or more hot zones wherein a first hot zone comprises successive kneading blocks elements over a length of at least 4 D followed by a left-handed element with D being the screw diameter, and one or more additional hot zones placed downstream the first hot zone are filled mixing zones, each comprising kneading blocks elements over a length of at least 4 D followed by a kneading left-handed element or by a left-handed element with D being the screw diameter.

3. The process according to claim 1 is characterised in that the thermal treatment is performed by self-heating of the material in a twin-screw extruder and in that the successive kneading blocks elements of at least one hot zone of the extruder comprise disks with disks offset by 90 degrees and a disk width of at least 0.3 D wherein D being the screw diameter and/or in that one hot zone of the extruder is or comprises the melting zone of the extruder.

4. The process according to claim 1 is characterized in that the maximum barrel temperature Ts is at least 355° C. and/or is at most 430° C.

5. The process according to claim 1 is characterized in that the maximum barrel temperature Ts is at least 390° C.

6. The process according to claim 1 is characterized in that the polypropylene-containing material is selected to have a melt index (MI₂ R) ranging from 0.1 to 20.0 g/10 min as determined according to ISO 1133-2011 at 230° C. under a load of 2.16 kg; preferably ranging from 0.2 to 10.0 g/10 min; more preferably ranging from 0.5 to 5.0 g/10 min; even more preferably ranging from 0.8 to 3.0 g/10 min.

7. The process according to claim 1 is characterized in that the grafting agent comprises or consists of one or more functional monomers selected from maleic anhydride, glycidyl methacrylate, methyl methacrylate, acrylic acid, butyl acrylate, vinyl acetate, diethyl maleate, acrylamide, acrylonitrile, and any mixture thereof;

8. The process according to claim 1 is characterized in that the grafting agent is provided in a content ranging from 1.5 to 4.0 wt. % based on the total weight of the polypropylene-containing material provided on step (b).

9. The process according to claim 1 is characterized in that the modified polypropylene composition recovered in step (e) has a melt index MI₂ ranging from 10.0 to 600.0 g/10 min as determined according to ISO 1133-2011 at 230° C. under a load of 2.16 kg; an Mz below 1,000,000 g/mol as determined by size exclusion chromatography; a ratio of complex viscosity at a frequency of 0.01 rad/sec to the complex viscosity at a frequency of 100 rad/sec of at most 8.0 said ratio being measured at 190° C., a tan delta at 0.1 rad at 190° C. above 2.5 and a grafting agent content of at least 0.2 wt. % based on the total weight of the modified polypropylene composition; preferably the modified polypropylene composition recovered in step (e) has an Mz below 600,000 g/mol as determined by size exclusion chromatography.

10. The process according to claim 1 is characterized in that the modified polypropylene composition recovered in step (e) has:
a complex viscosity at 0.01 rad/sec at 190° C. ranging from 50 to 2,000 Pa·s; and/or
an Mz/Mw of at most 7.0 as determined by size exclusion chromatography; and/or
an Mw/Mn ranging from 2.2 to 10.0 as determined by size exclusion chromatography.

11. The process according to claim 1 is characterized in that the grating agent is present in the modified polypropylene composition recovered in step (e) at a content ranging from 0.1 to 5.0 wt. % based on the total weight of the modified polypropylene composition.

12. The process according to claim 1 is characterized in that the step (d) of extruding the polypropylene-containing material comprises performing the extrusion with a residence time ranging from 5 seconds to 5 minutes.

13. The process according to claim 1 is characterized in that the step (d) of extruding the polypropylene-containing material comprises performing the extrusion at a screw speed ranging from 100 to 1200 rpm; preferably ranging from 300 to 900 rpm or from 400 to 800 rpm.

14. The process according to claim 1 is characterized in that step (d) of extruding comprises a thermal treatment of the polypropylene-containing material at a maximum barrel temperature Ts ranging from 345° C. to less than 400° C. in one or more hot zones of the extruder and in that the modified polypropylene composition recovered in step (e) has a tan delta at 0.1 rad at 190° C. equal to or greater than 8.0.

15. The process according to claim 14 is characterized in that the maximum barrel temperature Ts ranging from 345° C. to 375° C. in one or more hot zones of the extruder and in that the modified polypropylene composition recovered in step (e) has a tan delta at 0.1 rad at 190° C. equal to or greater than 15.0.

16. The process according to claim 1 is characterized in that step (d) of extruding comprises a thermal treatment of the polypropylene-containing material at a maximum barrel temperature Ts ranging from 400 to 430° C. in one or more hot zones of the extruder and in that the modified polypropylene composition recovered in step (e):
has a tan delta at 0.1 rad at 190° C. that is equal to or below the tan delta of the polypropylene-containing material; and/or
a complex viscosity at 0.01 rad/sec at 190° C. ranging from 50 to 300 Pa·s; and/or
has a melt index (MI₂ T) that is at least 50 times higher than the melt index of the polypropylene-containing material provided that the polypropylene-containing material is selected to have a melt index (MI₂ R) below 3.0 g/10 min as determined according to ISO 1133-2011 at 230° C. under a load of 2.16 kg.

17. The process according to claim 1 is characterized in that the process is devoid of a step of providing one or more peroxides, or in that the process comprises providing one or more peroxides wherein the content of peroxide is at most 500 ppm based on the total weight of the polypropylene-containing material.

18. Modified polypropylene composition characterized in that it is produced by the process according to claim 1 and that it has a melt index MI₂ ranging from 10.0 to 600.0 g/10 min as determined according to ISO 1133-2011 at 230° C. under a load of 2.16 kg; an Mz below 1,000,000 g/mol as determined by size exclusion chromatography; a ratio of complex viscosity at a frequency of 0.01 rad/sec to the complex viscosity at a frequency of 100 rad/sec of at most 8.0 said ratio being measured at 190° C., a tan delta at 0.1 rad at 190° C. above 2.5 and a grafting agent content of at least 0.2 wt. % based on the total weight of the modified polypropylene composition; preferably the modified polypropylene composition recovered in step (e) has an Mz below 600,000 g/mol as determined by size exclusion chromatography.

19. A method to produce a composite material is characterized in that it comprises in a first step producing a modified polypropylene composition from a polypropylene-containing material according to the process according to claim 1, and in a second step melt-blending the modified polypropylene composition with one or more fillers to produce a composite material; with preference, the polypropylene-containing material is a recycled polypropylene-containing material.

20. The method according to claim 18 characterized in that the one or more fillers are selected from talc mineral filler, wollastonite, calcium carbonate, modified calcium carbonate, coated calcium carbonate, glass fibres, wood fibres, bamboo fibres, flax fibres, hemp fibres, carbon fibres, metal fibres, graphite fibres, silica fibres, silica-alumina fibres, alumina fibres, zirconia fibres, boron nitride fibres, silicon nitride fibres, boron fibres, potassium titanate whisker, aluminium borate whisker, magnesium-based whisker, silicon-based whisker, carbon black, carbon nanotubes, graphene nanotubes, and any mixture thereof; with preference, the composite material is a wood-plastic composite comprising the modified polypropylene composition and wood fibres.
